(19) United States
(12) Patent Application Publication
(10) Pub. No.: US 2025/0239829 A1
(43) Pub. Date: Jul. 24, 2025

(54) COHERENT BEAM COMBINING LASER SYSTEM AND METHOD FOR FUSION

(71) Applicant: Blue Laser Fusion, Inc., Palo Alto, CA (US)

(72) Inventors: Trevor COHEN, Palo Alto, CA (US); Atsushi SUNAHARA, Palo Alto, CA (US); Hiroaki OHTA, Palo Alto, CA (US); Shuji NAKAMURA, Palo Alto, CA (US)

(21) Appl. No.: 18/417,637

(22) Filed: Jan. 19, 2024

(51) Int. Cl. H01S 3/067; G21B 1/03; G21B 1/23; H01S 3/00; H01S 3/10; H01S 3/16; H01S 3/23

(52) U.S. Cl. CPC H01S 3/06783; H01S 3/0057; H01S 3/10053; H01S 3/10061; H01S 3/1698; H01S 3/2308; G21B 1/03; G21B 1/23

(57) ABSTRACT

In an example, the present invention provides a system for amplifying a laser pulse. The system comprises a coherent beam combining (CBC) system coupled to an optical enhancement cavity each of which is configured to operably work together to amplify a laser pulse from a laser source through the CBC and then through the cavity.

### BACKGROUND OF INVENTION

The present invention relates generally to fusion energy generation techniques. In particular, the present invention provides a system and method for fusion energy using a high intensity pulse laser generation system, and related methods. Merely by way of example, the invention can be applied to a variety of applications, including energy generation for power, spaceships, travel, other vehicles for air, land, and water, defense applications (e.g., satellite, aerospace, land and missile defense, submarines, boats), biotechnology, chemical, mechanical, electrical, and communication and/or data applications.

From the beginning of time, human beings have developed energy sources from natural materials such as wood, coal, oil, and gas products. Unfortunately, burning wood and coal leads to major pollution issues, including adding undesirable carbon particles into the atmosphere. Oil and gas products also have similar limitations and have been a leading cause of “Global Warming,” Renewable energy sources including nuclear, wind, hydroelectric, and solar are promising. However, such renewable energy sources have other shortcomings. Wind only works if the wind is blowing. Solar cannot be used when the sun goes down Hydroelectric is limited to areas with water, and nuclear, although promising, has had major problems in generating waste and unreliable and dangerous reactors. One other promising energy source has been fusion energy.

Fusion energy is a type of energy production that occurs when two atomic nuclei fuse together, releasing a large amount of energy in the process. It is considered a potential source of clean and abundant energy, as the fuel for fusion reactions (mainly hydrogen) is abundant on Earth and the reactions produce no greenhouse gases or other harmful pollutants.

There are two main approaches to achieving fusion reactions: inertial confinement fusion (ICF) and magnetic confinement fusion (MCF).

Inertial confinement fusion (ICF) involves using high-energy lasers or particle beams to compress and heat a small pellet of hydrogen fuel, causing it to fuse. The fuel is typically a mixture of deuterium and tritium, two isotopes of hydrogen The fuel is contained within a small, spherical capsule called a hohlraum, which is placed at the center of a chamber filled with high-energy lasers or particle beams. When the lasers or particle beams are fired at the hohlraum, they create a uniform layer of x-rays that uniformly heat and compress the fuel inside the hohlraum. This causes the fuel to reach the necessary temperature and pressure conditions for fusion to occur.

The main advantage of ICF is that it can potentially produce fusion reactions with a relatively small amount of fuel and at a relatively low cost. However, the process is still in the experimental stage and there are significant technical challenges to before it can be considered a practical source of energy.

Magnetic confinement fusion (MCF) involves using strong magnetic fields to contain and heat a plasma (a hot, ionized gas) of hydrogen fuel, causing it to fuse. The most common type of MCF is called tokamak fusion, which uses a toroidal (doughnut-shaped) chamber to contain the plasma. The plasma is held in the center of the chamber by strong magnetic fields, which are created by running current through a set of coil windings around the chamber. The plasma is heated by injecting energy into it, either through particle beams or through electromagnetic waves.

The main advantage of MCF is that it has the potential to produce fusion reactions on a larger scale, making it more suitable for generating electricity. However, it is a more complex and costly process than ICF and there are still significant technical challenges to overcome before it can be considered a practical source of energy.

Both ICF and MCF have made significant progress in recent years and there are several experimental facilities around the world working on these technologies. However, achieving sustained fusion reactions with net energy production (meaning the energy produced by the fusion reactions is greater than the energy required to initiate and sustain the reactions) remains a major technical challenge.

There are also other approaches to fusion energy being explored, such as magnetized target fusion and muon-catalyzed fusion. However, these approaches are still in the early stages of development. It is not yet clear if fusion energy will be viable as a source of energy.

From the above, fusion energy has the potential to be a clean and abundant source of energy, but significant technical challenges should be overcome before it can be considered a practical source of energy.

### SUMMARY OF INVENTION

According to the present invention, techniques related generally to fusion energy generation techniques are provided. In particular, the present invention provides a system and method for fusion energy using a high intensity pulse laser generation system, and related methods. Merely by way of example, the invention can be applied to a variety of applications, including energy generation for power, spaceships, travel, other vehicles for air, land, and water, defense applications (e.g., satellite, aerospace, land and missile defense, submarines, boats), biotechnology, chemical, mechanical, electrical, and communication and/or data applications.

In an example, the present invention provides a method for coupling an amplified coherent beam combined laser pulse to an optically enhanced cavity. The method includes generating a laser pulse from a source laser device. The method includes generating at least two frequency-shifted reference sidebands in conjunction with the laser pulse. In an example, the two frequency shifted reference sidebands are generated such that each of the two frequency shifted reference side bands is at a lower power than the laser pulse from the source laser device. The method includes dividing the pulse laser into a plurality of independent beam paths, e.g., ranging from 2 to 10,000. Each of the independent beam paths has a divided laser pulse. Each of the divided laser pulses has at least two reference side bands, but can be fewer or more. In an example, the method includes increasing an intensity of each of the divided laser pulse using an amplification. The method includes adjusting a phase of each of the divided laser pulses to reduce a destructive interference of one or more of the at least two reference side bands. In an example, the method includes combining, using coherency, each of the divided laser pulses into a single amplified pulse and at least two reference sidebands. The method includes propagating the single amplified pulse with the two reference side bands between a pair of mirrors configured to form a cavity region. In an example, the method includes reflecting the at least two reference sidebands from at least one of the mirrors into a photodiode detector device to generate a signal to adjust a frequency of the source laser device using a control method to increase an injection efficiency of the laser pulse from a first efficiency to a second efficiency, where the first efficiency is less than the second efficiency.

In an alternative example, the present invention provides a method for amplifying a laser pulse from a low power, e.g., on order of 100 Watts, by a factor, e.g., of 1,000,000 times, among others. The method includes performing an active amplification of a laser pulse by pulse division of the laser pulse into a plurality of independent beam paths, e.g., ranging between 8 and 10,000. The method includes coupling each of the beam paths to a rare-earth doped fiber amplifier device followed by coherent combination of each of the independent beam paths to output a single amplified laser pulse, e.g., resulting in at least 1,000 times amplification of an intensity of the laser pulse. The method includes performing a passive amplification of the amplified laser pulse by injection of the amplified laser pulse into an optical cavity comprising a pair of mirror devices configured to form the optical cavity, each of the mirror devices having more than a 99.9% reflectivity of the amplified laser pulse such that a round-trip length of an intracavity laser pulse is matched with a timing of an injection of the amplified laser pulse causing additional amplification of an intensity of the amplified laser pulse to 1,000 times and greater.

In an alternative example, the present invention provides a laser system. The system has a single frequency continuous wave fiber laser source device (“laser device”) with a center wavelength, e.g., ranging between 1030 and 1050 nm with at least 0.1 nm resolution, to achieve an amplification gain and a stable frequency. In an example, the system has an arbitrary waveform generator device coupled to a RF driver device coupled to an acousto-optic modulator device coupled to the laser device capable of generating one or more laser pulses with either gaussian or flat-top shape, e.g., ranging between 100 ps and 20 ns. In an example, the system has an electro-optic modulator device coupled to the laser device capable of generating one or more reference sidebands. In an example, the system has a beam splitter device coupled to the laser device. The beam splitter device is configured to receive laser beam from the laser device and divide the laser beam into N paths, where N is an integer, e g., from 2 to 10,000, each laser beam in each path is amplified from a first energy level to a second energy level. In an example, the system has an auxiliary phase modulation device coupled to each N divided laser beam. The auxiliary phase modulation device is capable of shifting a phase of each laser pulse, e.g., at a MHz frequency. In an example, the system has a combiner device configured to receive the N laser beams and configured to spatially combine the N laser beams into an amplified pulse. In an example, the system has a second harmonic generation crystal device configured to receive the amplified pulse generating a frequency doubled laser pulse. In an example, the system has a third harmonic generation crystal device configured to receive the amplified pulse and the frequency doubled laser pulse generating a frequency tripled laser pulse.

In an example, the system has a Fabry Perot optically enhanced cavity (OEC) configured to receive the frequency tripled laser pulse. In an example, the Fabry Perot optical cavity comprising a first mirror device and a second mirror device, and a free space defined between the first mirror device and the second mirror device to form the Fabry Perot optical cavity. The frequency tripled amplified pulse propagates in the Fabray Perot optical cavity increases in energy intensity from a first intensity to a second intensity to an Mth intensity for M cycles between the first mirror device and the second mirror device, e.g., where M is greater than 10,000 cycles.

In an alternative example, the present invention provides a system for amplifying a seed laser. The system has a seed laser device generating a laser beam. The system has a splitter device coupled to the seed laser device to generate a plurality of divided laser beams from the laser beam. The system has an amplifier device coupled to each of the plurality of divided laser beams to amplify each of the plurality of laser beams to generate a plurality of amplified laser beams. In an example, the system has a coherent beam combining system coupled to the plurality of amplified laser beams and configured to generate a single amplified laser beam. The system has an optical enhancement cavity comprising a pair of mirrors configured to propagate and increase an intensity of the single amplified laser beam in a free space between the pair of mirrors.

Of course, one of ordinary skill in the art would recognize other variations, modifications, and alternatives.

Depending upon the example, the present invention can achieve one or more of these benefits and/or advantages. In an example, the present invention provides a fusion energy system including a high intensity pulse or continuous wave (CW) laser system configured with a reactor in a compact and spatially efficient system and related methods. In an example, the high intensity pulse or CW laser system provides enough energy to ignite and sustain fusion energy within the reactor. In an example, the present invention offers advantages of generating fusion power through an efficient size, weight, and cost using the present high intensity lasers. In an example, the present system and method is configured to reduce or eliminate parametric instabilities. These and other benefits and/or advantages are achievable with tie present device and related methods. Further details of these benefits and/or advantages can be found throughout the present specification and more particularly below.

A further understanding of the nature and advantages of the invention may be realized by reference to the latter portions of the specification and attached drawings.

### BRIEF DESCRIPTION OF THE DRAWINGS

In order to more fully understand the present invention, reference is made to the accompanying drawings. Understanding that these drawings are not to be considered limitations in the scope of the invention, the presently described embodiments and the presently understood best mode of the invention are described with additional detail through use of the accompanying drawings in which:

FIG. 1 is a simplified illustration of an Optical Enhancement Cavity (GEC) laser according to an example of the present invention.

FIG. 2 is a simplified illustration of incident laser energy absorbed near a turning point in plasma according to an example of the present invention.

FIG. 3 is a simplified illustration of a laser with spot radius Rb comparable to a target radius Rt irradiates a target according to an example of the present invention.

FIG. 4 is a simplified diagram illustrating Stimulated Brillouin Scattering (SBS) caused by an interaction of three waves of the incident laser, reflected laser, and ion acoustic wave according to an example of the present invention.

FIG. 5 is a simplified diagram illustrating Stimulated Raman Scattering (SR S) caused by an interaction of three waves of the incident laser, reflected laser, and electron plasma wave according to an example of the present invention.

FIG. 6 is a simplified diagram illustrating Two Plasmon Decay (TPD) caused by an interaction of three waves of the incident laser and two electron plasma waves according to an example of the present invention,

FIG. 7 is a simplified diagram of a multi-stage laser generation and amplification process according to an example of the present invention.

FIG. 8 is a simplified diagram illustrating a source laser derived from a single frequency continuous wave (CW) ytterbium-doped fiber laser centered at any wavelength between 1030-1050 nm according to an example of the present invention.

FIG. 9 is a simplified diagram of a quarter wave plate coupled into a polarizing beam splitter device, splitting the pulse into its original two pre-combined components in an example of the present invention.

FIG. 10 is a simplified diagram of a system according to an example of the present invention.

FIG. 11 is a simplified diagram of a laser fusion target with a small spot size (Rb<<Rt) so that interference with each other is minimized according to an example of the present invention.

FIG. 12 is a simplified illustrating of each beam irradiating without overlapping according to an example of the present invention.

FIG. 13 is a simplified illustration of a laser wavelength of the OEC laser beam shifted plus or minus 10 nm for a 1040 nm-wavelength light according to an example of the present invention.

FIG. 14 is a simplified illustrating showing an electron density distribution and energy flow when the laser is irradiated onto the target according to an example of the present invention.

FIG. 15 is a simplified illustration of a laser intensity inhomogeneity according to an example of the present invention.

FIG. 16 is a simplified overall diagram of a coherent beam combining laser system coupled to an optical enhancement cavity according to an example of the present invention.

FIG. 17 is a. simplified diagram of an arbitrary wavefront generator according to an example of the present invention.

FIG. 18 is a simplified diagram of a field programmable gate array system according to an example of the present invention,

FIG. 19 is a simplified diagram of a laser fusion reactor configured with a plurality of optical enhancement cavities according to an example of the present invention.

FIG. 20 is a simplified diagram of a waveform generator according to an example of the present invention

FIG. 21 is a simplified diagram of a source laser according to an example of the present invention.

FIG. 22 is a more detailed diagram of a coherent beam combining (CBC) laser system according to an example of the present invention.

FIG. 23 is a more detailed diagram of a CBC laser system with sidebands coupled to an optical enhancement cavity according to an example of the present invention.

FIG. 24 is a simplified diagram of a source laser according to an example of the present invention.

FIG. 25 is a simplified diagram of a laser configured for frequency multiplication according to an example of the present invention.

FIG. 26 are simplified illustrations of laser combinations according to an example of the present invention.

FIG. 27 is a simplified diagram of a half wave plate device according to an example of the present invention.

FIG. 28 is a simplified diagram of a quarter wave plate device according to an example of the present invention.

### DETAILED DESCRIPTION OF THE SPECIFIC EXAMPLES

According to the present invention, techniques related generally to fusion energy generation techniques are provided. In particular, the present invention provides a system and method for fusion energy using a high intensity pulse laser generation system, and related methods. Merely by way of example, the invention can be applied to a variety of applications, including energy generation for power, spaceships, travel, other vehicles for air, land, and water, defense applications (e.g., satellite, aerospace, land and missile defense, submarines, boats), biotechnology, chemical, mechanical, electrical, and communication and/or data applications.

This invention provides a novel laser irradiation approach to direct-drive laser thermonuclear fusion using Optical Enhancement Cavity (OEC) laser technology. The method focuses on irradiating a fusion fuel target with multiple OEC laser beams while minimizing spatial beam-overlapping. Also, the wavelength, direction of polarization, and phase are able to be shifted between adjoint beams. This enhances the absorption of laser energy by the target plasma, reduces disturbances or preheating that impede efficient thermonuclear ignition, and makes it easier to ensure one-dimensional sphericity during implosion. A physical challenge addressed by our invention is the suppression of parametric instabilities like Stimulated Brillouin Scattering (SES), Stimulated Raman Scattering (SRS), and Two Plasmon Decay (TPD), among others. Unlike traditional methods which use the incident light having a broad bandwidth to mitigate these instabilities, our approach utilizes Optical Enhancement Cavity (OC) technology to employ traditional Nd: YAG and rare-earth metal doped fiber lasers or their harmonics as a laser light source not having broad bandwidths. It irradiates the target with a number of laser beams having a smaller spot size than the target size. Or it irradiates the target with a number of OEC laser beams with a different wavelength having an almost the same size of the laser spot size as the target size. This results in improved laser absorption fraction and irradiation uniformity, minimized generation of energetic electrons and enables cost-effective construction of the system with a number of laser beams. The design optimizes mirror sizes in the OECX, allowing the increase of the damage threshold of the mirror and generating higher power laser light suitable for the laser thermonuclear fusion ignition and burn. The invention has advantages and/or benefits, e.g., efficient and uniform laser irradiation, reduced costs, and advancements in direct-drive laser fusion of inertial confinement fusion technology.

Direct-drive laser thermonuclear fusion irradiates a thermonuclear fuel target with a number of laser beams, causing it to implode towards its center of the target, then achieving a high-density, high-temperature plasma state to realize the thermonuclear fusion ignition and burn. When laser beams irradiate the target, its surface ablates, and the target shell accelerates inwardly driven by the high pressure of the ablation plasmas. During this implosion process, a portion of the absorbed laser energy becomes the kinetic energy of the shell directed toward the center. As implosion proceeds, this kinetic energy of the shell transforms into internal energy of a densely compressed shell “main fuel part” and a hot spark region at the center of the target. When the temperature of the hot spark region is increased up to the ignition temperature, thermonuclear ignition occurs, and then the thermonuclear burn wave propagates from the high-temperature hot spark region into the high-density main fuel surrounding the hot spark. During the propagation of the thermonuclear wave, the fusion energy is released.

To initiate the thermonuclear ignition efficiently, it is desirable to ensure that the laser energy irradiated on the target is absorbed with a high absorption fraction. The absorbed laser energy is used to generate the high-dense and high-temperature plasma conditions, and a part of the absorbed energy is transformed into the kinetic energy of the imploding shell. Eventually, the kinetic energy of the imploding shell is transformed into the internal energy of the hot spark and the main fuel. As the amount of the absorbed laser energy increases, the internal energy of the hot spark can be increased, namely, a higher temperature hot spark can be formed.

The one-dimensional spherical symmetry of the implosion is also desirable. Seeds of disturbances such as the non-uniformity of laser irradiation and the non-sphericity of the target grows due to the hydrodynamic instabilities during the implosion process, resulting in significant deviations from one-dimensional spherical implosion. This asymmetrical motion drastically degrades the conversion efficiency from the kinetic energy of the imploding shell to the internal energy of the main fuel or the high-temperature hot spark, and in such a case, the kinetic energy of the imploding shell is maintained to grow the asymmetrical motion and hindering the formation of a high-density and high-temperature plasma condition.

To reduce or even minimize deviations from the one-dimensional spherical symmetry of the implosion, improving the uniformity of laser irradiation on the target is desirable for laser fusion. In the actual implosion, a finite number of laser beams irradiate the spherical target. To ensure irradiation uniformity, each beam spot radius Rb is set comparable to the target radius Rt, and each beam overlaps to irradiate the target in the conventional method. As a result, the spatial beam intensity distribution of each beam is superimposed, achieving a spatial smoothing irradiation profile on the target.

For example, the OMEGA laser at the University of Rochester has conducted direct-drive laser fusion implosion experiments with sixty (60) laser beams, and the GXII laser at Osaka University in Japan uses twelve (12) laser beams, performing implosion with Rb approximately equal to Rt to obtain relatively better laser irradiation uniformity on the target for the one-dimensional spherical symmetry of the implosion.

Also, each laser beam is transformed from coherent light to incoherent light with the random phase plate (RPP) or Smoothing by Spectral Dispersion (SSD) technique. By using this technique, the interference pattern due to the beam overlapping is further smoothed.

To achieve efficient thermonuclear ignition, it is also crucial to minimize parametric instabilities arising from the interaction between lasers and plasma, in addition to efficient laser energy absorption and high laser irradiation uniformity. The parametric instabilities, including Stimulated Brillouin Scattering (SBS), Stimulated Raman Scattering (SRS), and Two-Plasma Decay (TPD), occur when laser electromagnetic waves combine with waves within the plasma (ion acoustic waves or electron plasma waves) by fulfilling the matching condition regard to frequency and wave-vector.

As a result, in the case of SBS, a phenomenon called Cross Beam Energy Transfer (CBET) occurs, converting part of the energy of incident light into scattered light energy before absorption of the incident light by the target plasma, and results in a decrease in the effective laser absorption fraction, and also modulation of beam intensity distribution occurs, which hinders uniform irradiation. This CBET has been unintentionally increased with an increase of the beam-overlapping to obtain uniform irradiation on the target and it has caused the lowering of the laser absorption.

In the case of SRS, the incident light couples with an electron plasma wave and scattered light in the plasma. Similar to SBS, this leads to an increase in scattered light energy, reducing the energy absorption fraction of the incident laser. Moreover, the excitation of electron plasma waves accelerates energetic electrons. These accelerated energetic electrons preheat the entire imploding shell, hindering the achievement of high-density plasma by the increase of the entropy of the imploding shell. Therefore, it's important to suppress the SRS and less generating energetic electrons.

TPD also excites electron plasma waves in the plasma, leading to the generation of energetic electrons preheating the imploding target plasma. Hence, like SRS, it's important to suppress TPD as much as possible. As mentioned above, the parametric instabilities such as SBS, SRS, and TPD have been recognized that they should be suppressed for efficient direct-drive laser fusion implosion.

A traditional method to suppress these parametric instabilities is detuning so as to not meet the matching conditions by broadening the bandwidth of the incident light. If the bandwidth of the laser is broadened, most part of the spectral component of the laser does not fulfill the same matching condition and the growth of the strong parametric instability is minimized.

Today, the lasers with broad band widths, such as ArF excimer lasers with a wavelength of 19.3 nm, which have a THz order bandwidth, are considered suitable for detuning, Therefore, they are expected to be useful light sources in laser fusion, suppressing parametric instabilities.

However, high-power excimer lasers applicable for laser fusion are still in the research and development stage and the M-energy class ArF laser system required for the laser thermonuclear fusion reactor hasn't been realized.

Our technique enables ensuring larger laser absorption fraction, smoother and more uniform irradiation on the target, and reduction of the generation of the energetic electrons preheating the target while we use the conventional relatively narrow bandwidth laser source.

Our present technique addresses advancements of the laser irradiation method onto the fusion fuel target in direct-drive laser thermonuclear fusion. In this method, a thermonuclear fuel target is irradiated with a number of Optical Enhancement Cavity (OEC) laser beams with a different wavelength and/or minimizing beam-overlapping each other, relaxing the parametric instabilities, and causing it to implode to reach a high-density, high-temperature plasma condition, enabling efficient thermonuclear fusion ignition with less laser energy.

### Achieving Efficient Thermonuclear Ignition Generally Requires:

High absorption fraction of laser energy by the target plasma.

The higher amounts of absorbed laser energy can be converted to the internal energy of the higher-temperature hot spark.

### One-Dimensional Sphericity During the Implosion:

Disturbances can cause deviations from this spherical symmetry, reducing the conversion efficiency of the kinetic energy of the imploding shell to its internal energy, and hindering the high-dense and high-temperature plasma conditions desired for the laser thermonuclear fusion.

### Reduction of the Parametric Instability:

The other challenge is the occurrence of parametric instabilities, such as Stimulated Brillouin Scattering (SBS), Stimulated Raman Scattering (SRS), and Two-Plasma Decay (TPD), during the interaction between lasers and plasma. These instabilities can lead to reduced absorption of incident light, unexpected modulation of the spatial laser profile, and the production of energetic electrons, affecting the implosion process.

The traditional method to suppress these instabilities has been broadening the bandwidth of the incident light.

The primary innovation presented is the use of the present laser irradiation method with Optical Enhancement Cavity (OEC) laser technology. This technology allows the utilization of traditional Nd: YAG and rare-earth metal fiber lasers or their higher harmonic waves as a light source that doesn't have the broad bandwidth of its light, enhancing the absorption of the incident laser light by the target plasma, improving the irradiation uniformity, and reduced parametric instabilities resulting in minimizing the generation of highly energetic electrons preheating the imploding target. Without the usage of the wide bandwidth of the incident light such as the excimer laser, we can diminish the parametric instabilities such as SBS, SRS, and TPD.

The OEC uses a cavity with facing mirrors to amplify laser power, allowing the construction of a number of laser beams at lower costs than conventional methods. By adjusting the size of OEC mirrors, each laser beam can irradiate a fusion target while minimizing these overlapping. In addition, by adjusting the wavelength, direction of polarization, and phases, each laser beam can irradiate a fusion target to minimize the parametric instabilities of SBS, SRS and TBD as mentioned above without the irradiation nonuniformity affecting the implosion. This method maximizes the absorption fraction by the inverse Bremsstrahlung process, ensuring uniform laser irradiation onto the target and minimizing the occurrence of parametric instabilities.

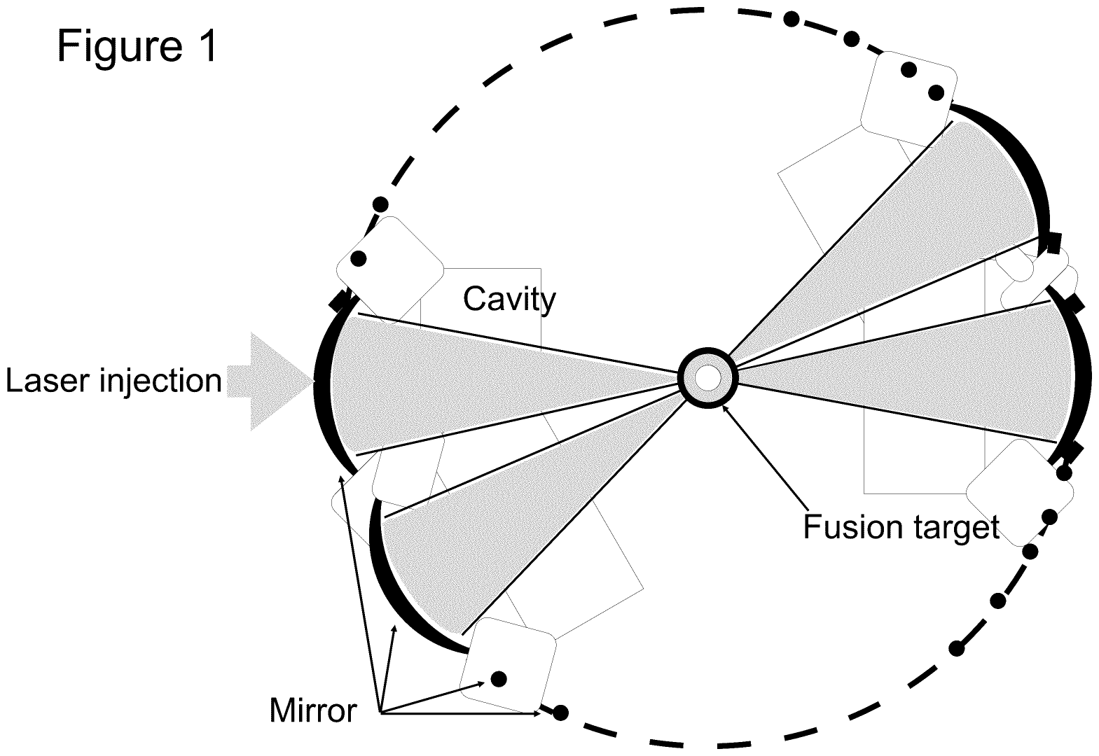

This technique addresses suppressing parametric instabilities by using Optical Enhancement Cavity (OEC) laser technology which even traditional Nd: YAG lasers or their harmonics can be adopted as a light source as shown in FIG. 1. This allows for maximizing the absorption of incident laser light by the target plasma. As a result, the generation of energetic electrons can be minimized, and results in the reduction of the preheating of the target. Additionally, it becomes easier to improve irradiation uniformity, and optimization of the target design of the direct-drive laser fusion becomes relatively simple Therefore, achieving a high-density, high-temperature plasma state becomes more straightforward, requiring less laser energy for the thermonuclear ignition.

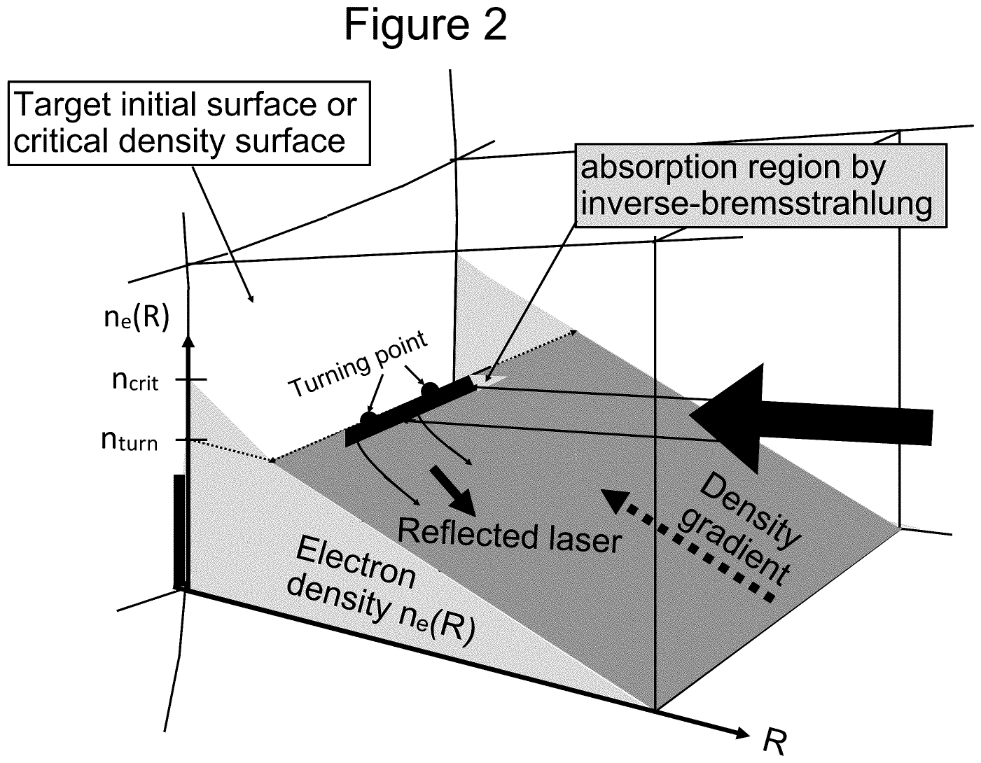

For laser fusion, the laser energy is mainly absorbed into the plasma by the inverse-bremsstrahlung mechanism. In this mechanism, the energy of electron quiver motion driven by the laser electric field thermalizes due to the collision with the ions. As the incident laser reaches to higher density in the plasma, the higher collisional frequency of electrons and ions gives the larger laser absorption fraction. Thus, the incident laser energy is mainly absorbed near the turning point in the plasma as shown in FIG. 2. When the laser incident is anti-parallel to the radial direction of the target represented in the R-axis in FIG. 2, normal to the target surface, and parallel to the density gradient, the laser can reach the critical density nₑᵣ, and a high laser absorption fraction can be obtained. On the other hand, if the laser incidents with angles to the plasma density gradient, the laser can reach only the turning point having the plasma density nₜᵤᵣₙ smaller than the critical density (nₜᵤᵣₙ≤nₑᵣ), and results in lower laser absorption. In this case, the less absorption of the incident laser leads to an increase in the reflected light.

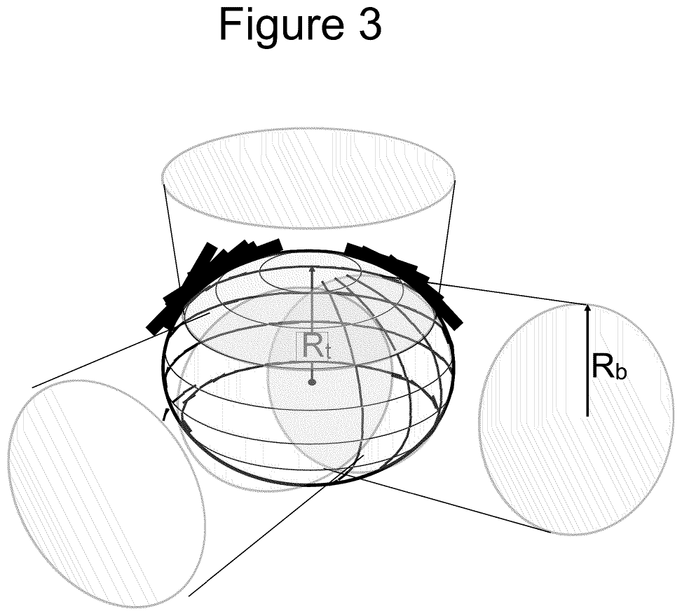

In general, the laser fusion target has a spherical shape. Thus, if the laser with spot radius Rb comparable to the target radius Rt irradiates the target, the outer beam in the laser spot apart from the beam axis is injected inclined incident to the normal direction with respect to the critical surface or target surface as shown in FIG. 3. As a result, the laser absorption fraction is reduced. Despite the decrease in laser absorption rate, ensuring the uniformity of the laser irradiation on the target by overlapping the laser beams having laser spots comparable to the target size is prioritized in the current direct drive implosion experiments of the laser fusion. Our invented irradiation method with OEC laser beams maximizes the laser absorption fraction while ensuring the irradiation uniformity on the target.

Next, we address the parametric instability. Conventionally, Nd:YAG or its higher harmonics light with relatively narrow bandwidths has been used as the laser driver for laser fusion. For NIF (National Ignition Facility of Lawrence Livermore National Laboratory) and OMEGA (University of Rochester) laser facilities, 0.35 micron third harmonics of Nd:YAG have been used. The parametric instabilities have been caused by the interaction of such relatively narrow bandwidth light with the plasma, and also a desirable issue for the future laser fusion reactor as well as the present laser fusion experiment.

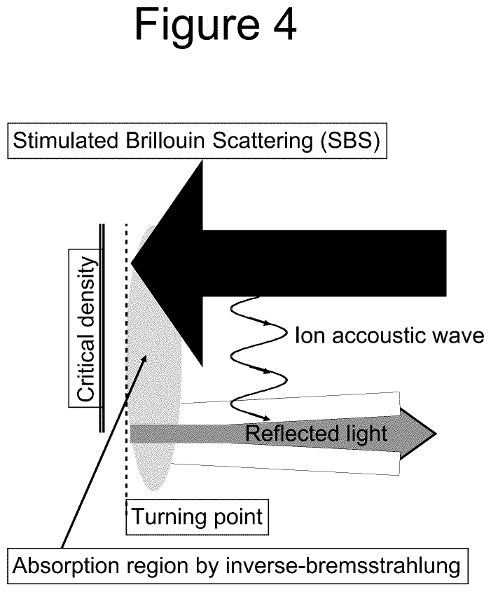

The parametric instabilities include SBS, SRS, and TPD as shown in FIGS. 4-6, respectively.

SBS is caused by the interaction of three waves of the incident laser, reflected laser, and ion acoustic wave as shown in FIG. 4. Once SBS occurs, part of the incident laser energy is transferred to the reflected light through the ion acoustic waves before the incident laser reaches the high absorption region around the turning point, resulting in decreasing the incident laser, increasing reflected light, and, the laser absorption fraction into the plasma is reduced.

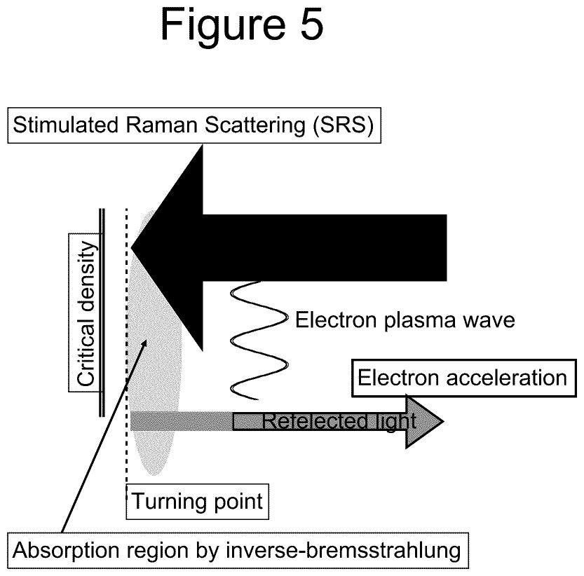

Similarly, SRS is caused by the interaction of three waves of the incident laser, reflected laser, and electron plasma wave as shown in FIG. 5. Once SRS occurs, the part of the incident laser energy is transferred to the reflected light or scattered light through the electron plasma waves before the incident laser reaches the high absorption region around the turning point, and results in decreasing the incident laser and increasing reflected or scattered light. As a result, the laser absorption fraction into the plasma is reduced. A more problematic thing is the generation of the energetic electrons accelerated by the electron plasma waves. These energetic electrons preheat the imploding target plasma and hinder the plasma compression required for the thermonuclear ignition.

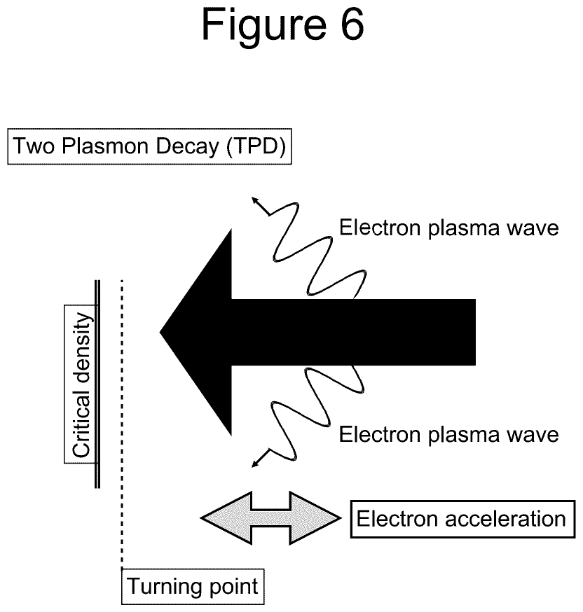

TPD is caused by the interaction of three waves of the incident laser and two electron plasma waves as shown in FIG. 6. Similar to SRS, the energetic electrons are accelerated by the electron plasma waves, and they preheat the imploding target.

In addition to the reduction of the laser absorption and preheating of the imploding target, these instabilities modulate the spatial intensity profile of the laser beam, and they degrade the laser irradiation uniformity on the target surface, leading to difficulties in achieving the high-dense and high-temperature plasma condition. Thus, the parametric instability denoted above has to be diminished to the efficient thermonuclear ignition.

The OEC uses a cavity with two facing mirrors to amplify the laser power synchronized injected in the cavity, allowing beams to be constructed with much lower costs than those of conventional laser beams with the media for laser amplification. Traditionally, for the design of the laser system for laser fusion, there has been a conflict between the desire to increase the number of laser beams for better uniform irradiation on the target and the increased cost associated with more beams. A compromise has been required in determining the number of beams in a laser system within the limitation of the construct cost of the laser system. However, with the OEC laser system, laser beams can be constructed much cheaper than traditional methods, allowing for a larger number of laser beams.

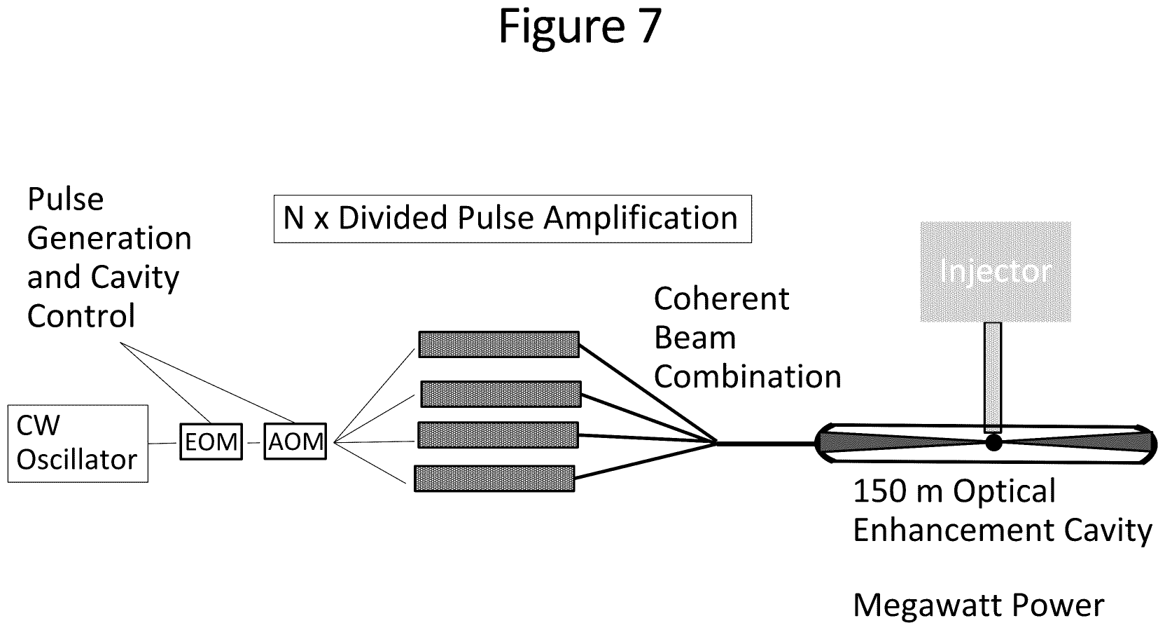

Methods for generating a high enough power laser pulse to inject into the OEC for further amplification are necessary to maximize wall plug efficiency and resultantly lower costs. Additionally, other specifications such as frequency bandwidth, phase, polarization, and beam uniformity should be precisely controlled to maximize injection efficiency into the cavity. As such, we present a method to generate nanosecond and picosecond pulses followed by high-efficiency amplification utilizing the coherent beam combination (CBC) method to reach sufficiently high enough power and that can be finely tuned to inject into the OEC. A simplified diagram of this multi-stage laser generation and amplification process can be found in FIG. 7.

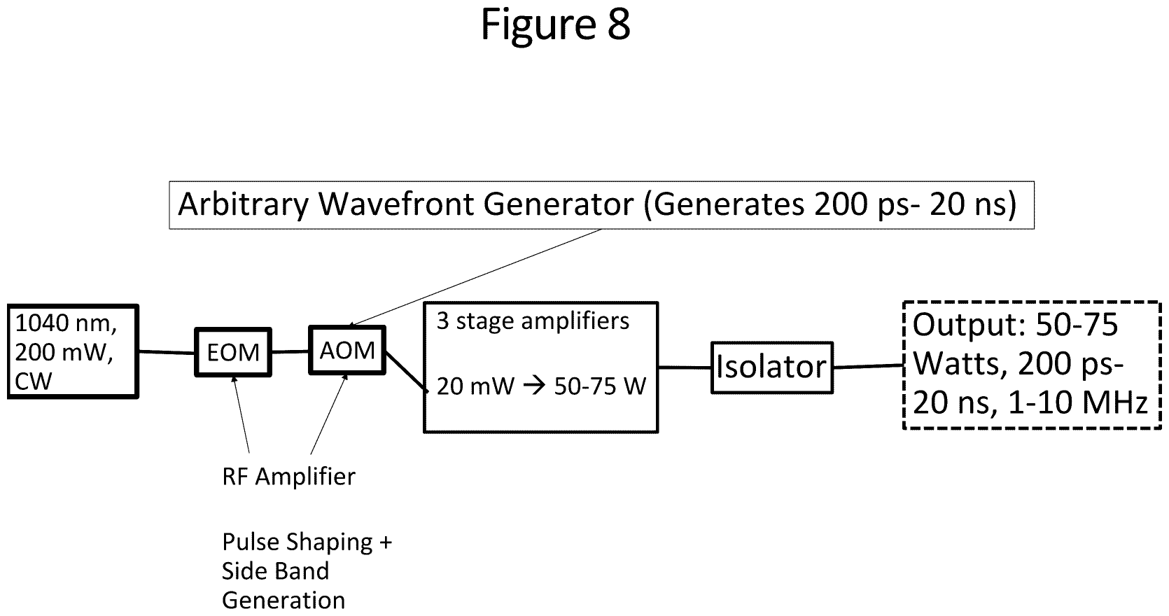

In an example, the source laser is derived from a single frequency continuous wave (CW) ytterbium-doped fiber laser centered at any wavelength between 1030-1050 nm, as seen in FIG. 8. In an example, the wavelength range has been shown to achieve the highest gain when coupled to ytterbium doped fiber amplifiers yielding the highest efficiency amplification. This provides the stable frequency and high precision frequency control necessary for optimal injection into the OEC. An arbitrary wave generator device is coupled to an RF driver coupled to an acousto-optic modulator coupled to the CW fiber laser, resulting in the generation of stable gaussian or flat top pulse lasers ranging from 200 ps-20 ns, but can be others Additionally, a RF driver is coupled to an electro-optic modulator device to generate reference sidebands needed to optimize the injection efficiency into the GEC. These sidebands should be generated at the start of the pulse generation and maintained through the entire laser system by means of precise phase control due to the low damage threshold of the electro-optic modulator devices. The pulse laser is then pre-amplified from a lower power level to a higher power level before further high-efficiency amplification using CBC.

In an example, the pre-amplified laser pulse is divided using a polarization-based pulse division technique to create 2^{N} number of pulses by means of a polarizing beam splitting device. The polarization of the pre-amplified laser pulse is modulated so that the resultant polarization is comprised of equal parts horizontal and vertical light. The polarized laser pulse is then coupled to a polarizing beam splitter device, resulting in a. 50:50 division of power into two beam paths. This polarization and division process is repeated in each beam path until the desired number of pulses is achieved, After pulse division, each laser pulse is coupled to an electro-optic modulator coupled to a rare-earth doped fiber amplifier, amplifying from a lower power level M to a higher power level N. Each beam path can be amplified with high efficiency due to the lower input power of each individual pulse.

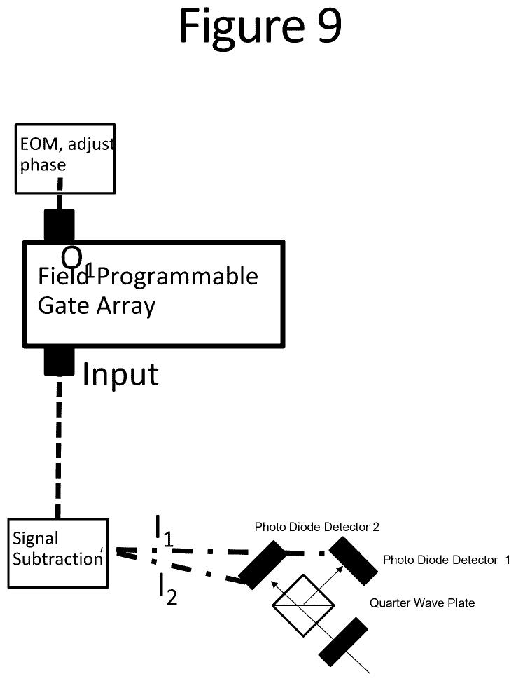

Once amplified, each divided pulse is recombined utilizing a multi-stage polarization-based coherent beam combination technique. To perform polarization-based CBC, two pulses, one comprising of vertically polarized light and the other comprising of horizontally polarized light, are directed and coupled into a polarizing beam combiner device, yielding one amplified pulse containing equal amounts of vertically and horizontally polarized light. For the highest efficiency combination, the two pulses before combination should be phase-matched, To monitor this phase matching, the combined pulse is sampled by coupling a beam-sample device to the beam path. The sampled pulse is coupled into a quarter wave plate coupled into a polarizing beam splitter device, splitting the pulse into its original two pre-combined components as seen in FIG. 9. These two pulses are coupled into photodiode detector devices and their output intensities are subtracted from each other. This subtracted signal is sent through a field programmable gate array device to generate a signal capable of driving the electro-optic modulators located before each rare-earth doped fiber amplifier, correcting the phase of the beam paths for the following generated pulses. This monitoring and phase modulating method is repeated after each beam combination event until the beams are combined into one amplified pulse. This amplified pulse is then injected into the OEC for further amplification.

In an example, the Pound Drever Hall method is used to achieve high efficiency injection and amplification into the optically enhanced cavity. The amplified laser pulse generated from the CBC system is coupled to a half wave plate device ensuring the polarization of the pulse is comprised of only vertical light. The vertical light is pumped into a nonlinear crystal device such as a lithium triborate crystal, but can be others, resulting in Type I 1+1 harmonic conversion producing green light between 515 nm and 525 nm. Type I second harmonic generation is chosen for its higher efficiency. An additional harmonic crystal such as a lithium triborate crystal, but can be others, is coupled to the beam path in order to perform Type I 1+2 harmonic conversion, producing UV light between 343.33 nm and 350 nm. Green and UV light are chosen for their improved ignition efficiency. The vertically polarized laser pulse is coupled to a polarizing beam splitter device which does not perturb the laser pulse on the first pass. The laser pulse is then coupled to a quarter wave plate device coupled to the cavity injection mirror converting the light to comprise of equal amounts vertical and horizontal polarization light. Upon imperfect injection, a portion of the laser pulse and side bands generated at the source laser device is reflected back through the quarter waveplate device converting the light to horizontal polarization and coupled to the polarizing beam splitter device, now reflecting the light along a new pathway. The redirected laser pulse is detected and coupled to a photodiode detector device, converting the light to an electronic signal. The electronic signal is coupled to a filtering device and signal mixer device to produce a difference signal. The difference signal is coupled to a field programmable gate array that generates a RF signal that modulates the frequency and phase of the output of the source laser device. This feedback loop, is designed to increase the amplification efficiency, lowering overall cost of the laser system.

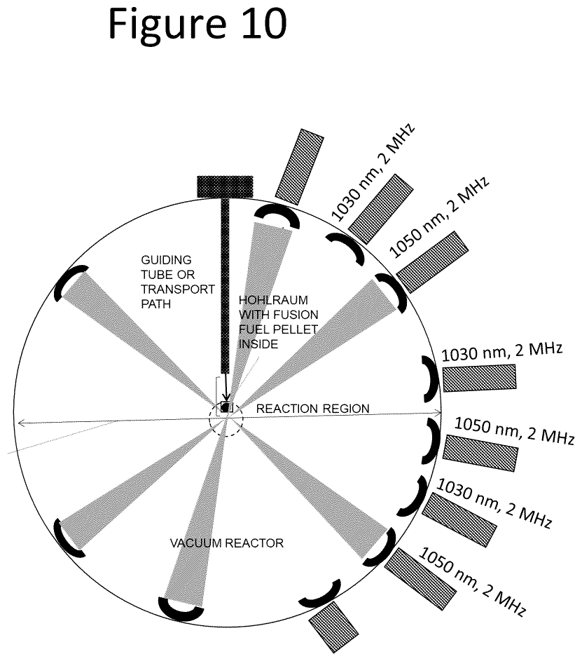

High-finesse optical cavities such as those described in the OEC device generate small bandwidth intracavity laser pulses as a consequence of the highly reflective cavity mirror faces. Resultantly, a high-finesse optical cavity cannot be used as a light source for inertial confinement fusion under normal conditions. To circumvent the inherent short bandwidth, many cavities will be installed, each with a unique center wavelength, effectively increasing the bandwidth of the laser pulse at the interaction junction between the lasers and target fuel as shown in FIG. 10. Increasing the number of laser beams irradiating the target fuel, in addition to decreasing overlap of the pulses at the center, increases the bandwidth at the interaction area as shown in FIG. 10.

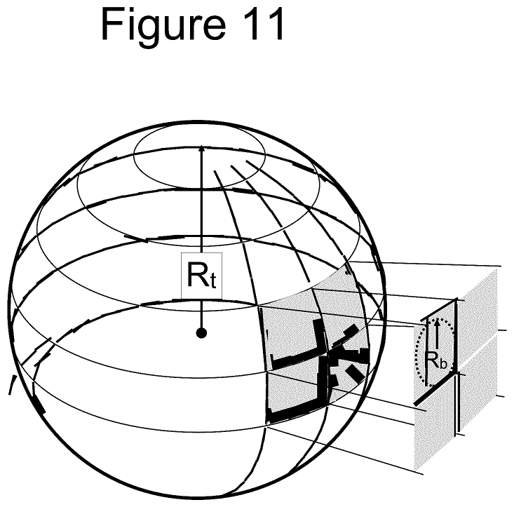

In this technique, by enlarging the size of OEC mirrors, each laser beam is designed to irradiate a laser fusion target with a small spot size (Rb<<Rt) so that their interference with each other is minimized as shown in FIG. 11. Here, enlarging the OEC mirrors also contributes to increasing the damage threshold of the mirror, making it possible for the realization of more high-power lasers required for laser fusion. While enlarging the mirrors of the OEC can lead to higher costs for each mirror, compared to a traditional laser system that uses the media of laser amplification, the increase of the number of laser beams by OEC can be realized much more affordably.

Here, as an example, we assume the number of laser beams with OEC to be 360. Also, the initial size of the fusion target is assumed to be 4 mm. Initially, when 360 laser beams with a diameter of 4 mm irradiate a target without overlapping, the irradiation area per beam is 1.396×10⁻³ cm⁻² approximating 374 μm×374 μm. When 360 beams irradiate a 200 μm diameter of the inflight target without overlapping, the irradiation area per beam is 3.49×10⁻⁶ cm⁻², approximating 19 μm×19 μm.

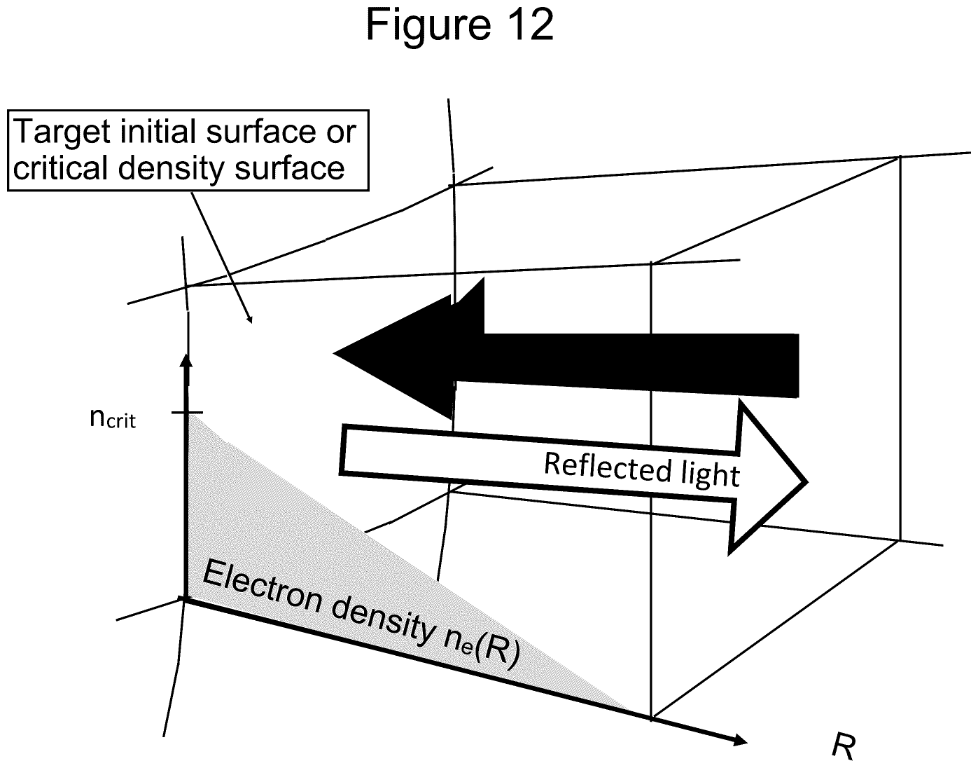

The spot size of each laser beam in both cases is much smaller compared to the target size, and each laser beam will mostly be incident vertically to the spherical target surface for the initial target or the critical density surface of the inflight target shell. As each beam irradiates without overlapping, as shown in FIG. 12, only the incident light and the reflected light that is reflected back without being absorbed at the critical density, interfere along the same axis.

When the laser beam irradiates the target surface or critical density surface with mostly vertical incident, the incident laser light is effectively absorbed by the inverse Bremsstrahlung process.

The absorption fraction of the incident laser is angle-dependent, with vertical incidence having the highest absorption. As the angle of laser incidence with regard to the plasma density gradient deviates from vertical, the absorption rate decreases. This is because vertically incident light can reach higher densities and is absorbed by more collision between electrons and ions in the inverse-bremsstrahlung.

When reflected light returning from the target surface or the critical density without absorption by the plasma is relatively large and meets the matching conditions among the incident laser, reflected laser, and waves launched in the plasma, as stated, energy transfer occurs from the incident laser to the reflected laser, and then the reflected laser light is further enhanced by parametric instabilities like SBS and SRS, As a result, when the angle of incidence is large, parametric instabilities reduce the absorption rate of incident light in plasma. At the same time, more energetic electrons are generated by SRS and TPD preheating the compression target.

In this technique, the OEC laser beams mostly vertically irradiate the target surface or critical density surface with a smaller spot than the target size, so the incident light can reach critical density, maximizing the absorption fraction by the inverse Bremsstrahlung process. Thus, the power of the reflected or scattered light from the target is minimized. Accordingly, the interference between neighbor laser beams is minimized. This significantly reduces the occurrence of parametric instabilities, maximizes the absorption fraction of the incident laser light to the target plasma, suppresses the modulation of the spatial intensity distribution of the laser beam, and suppresses the generation of energetic electrons preheating the compression target.

Next, the actual condition where multiple OEC laser beams are irradiated onto a target with a small spot size is concerned. Ideally, if the spatial intensity pattern of each beam is uniform and each beam can cover the entire 4π solid angle on the target without gaps, a uniform irradiation intensity distribution can be achieved on the target as shown in FIG. 11. In reality, it is difficult for multiple laser beams to irradiate the target without overlapping each other because the intensity profile of each laser beam has a smooth tail in space. To suppress the parametric instabilities in this beam-overlapping region, the adjoint OEC laser beam has a slightly different laser wavelength.

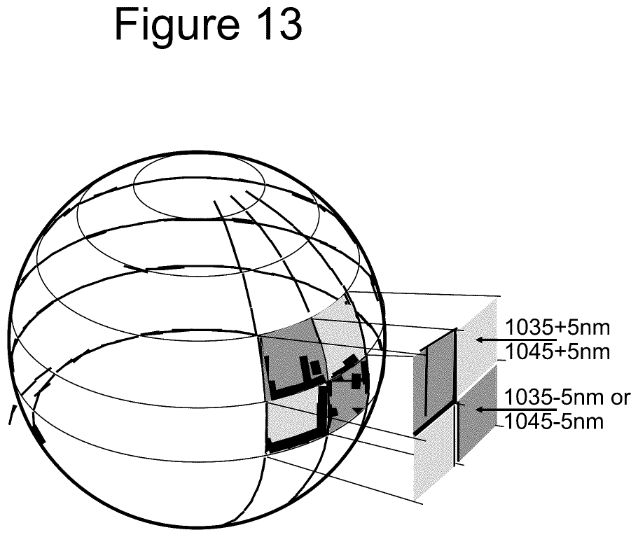

For example, the laser wavelength of the OEC laser beam can be shifted plus or minus 10 nm for a 1040 nm-wavelength light case as shown in FIG. 13. If the adjoint laser beam overlaps each other, each beam has a slightly different wavelength, and then both beams are detuned not to meet the strong condition of the parametric instability.

Also, the interference pattern in the overlapping tail of OEC laser beams moves on the target with time due to the difference in the laser wavelength. This can contribute to the smoothing out of the laser speckle pattern derived by the interference of the beams.

Furthermore, the direction of the polarization and phase of the adjoint laser beam can be set to be different in our OEC laser. Inherently, the center wavelengths of each cavity are different, thus yielding different polarizations and phases at the target fuel. This leads to the different motions of the speckle pattern and contributes to the smoothing of the laser beam intensity profile on the target. The direction of the polarization, the wavelength and the phase of the adjoint laser beam can be set to be different in our OEC laser. When the parametric instabilities are minimized only by adjusting the different wavelength, different direction of polarization, and different phases of adjoint laser beams of OEC, the laser beam sizes at the target region can be as large as the same size of the target size.

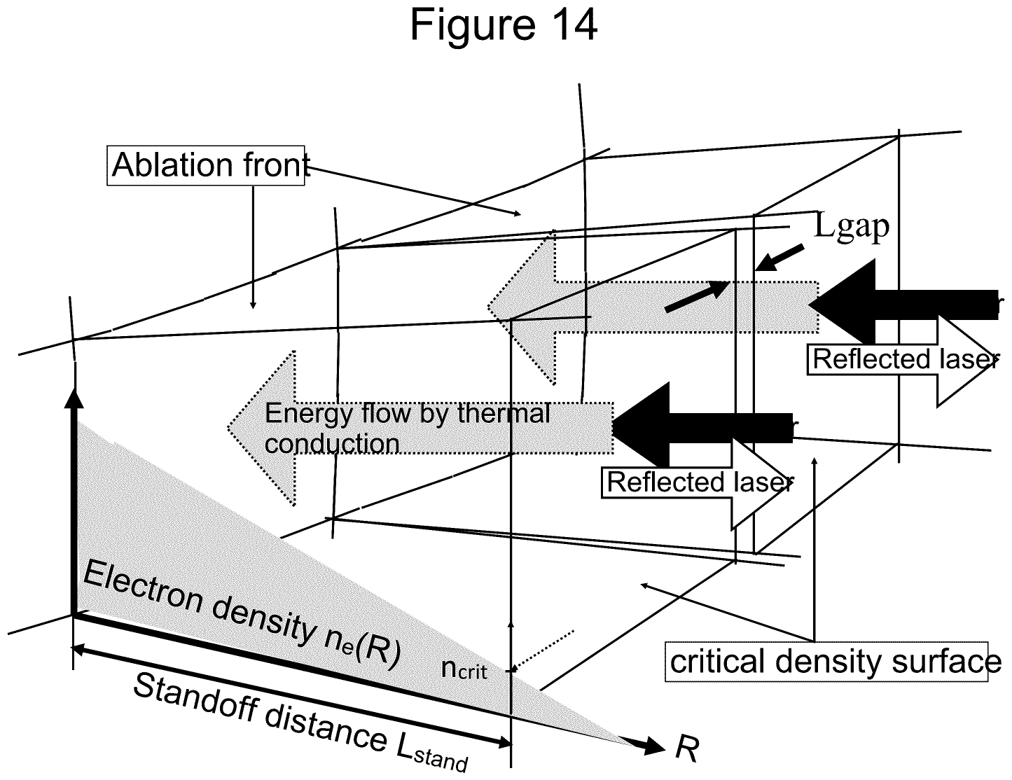

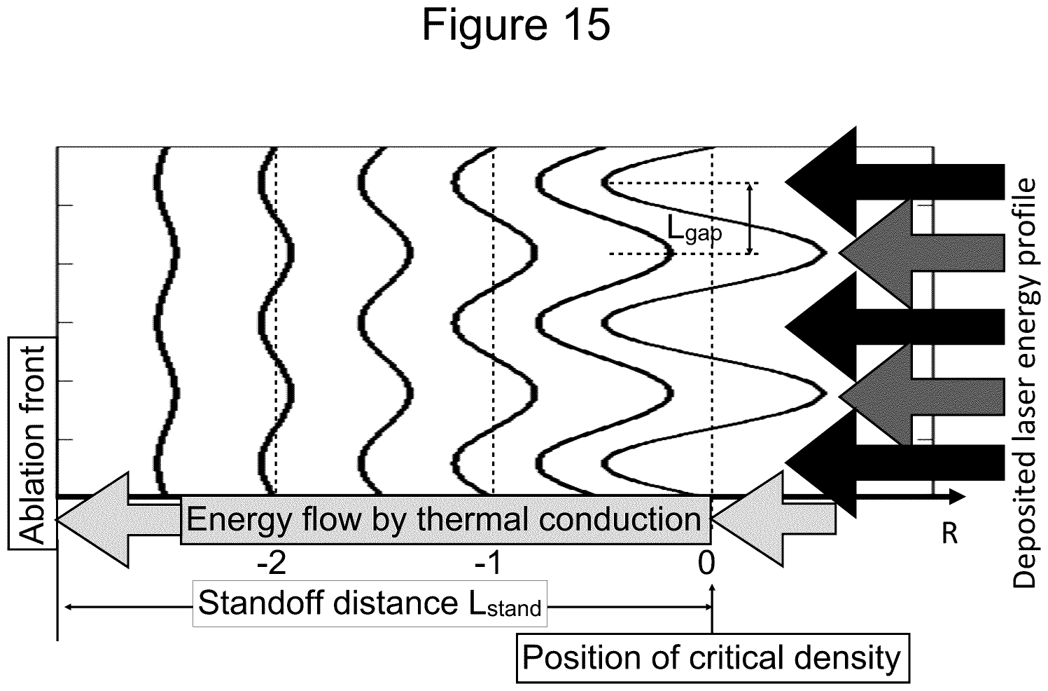

In addition, the laser speckle pattern of short-wavelength laser intensity disturbance is not a problem except in the initial stages of implosion. FIG. 14 shows the electron density distribution and energy flow when the laser is irradiated onto the target. When a laser is irradiated onto the target and ablation occurs, the laser penetrates only tip to the critical density, and then the absorbed laser energy is conducted by electron heat conduction to the ablation front where transferred enemy is used for the kinetic energy of the ablation plasma. At this time, the distance from the ablation front to the critical density is called the standoff distance, L_{stand}. When a laser is irradiated onto the target, the standoff distance increases over time and becomes almost constant at 50 μm to 600 μm. At this time, even if a laser intensity inhomogeneity with the spatial width L_{gap} due to the interference of the adjacent laser beams occurs near the critical density, its amplitude of spatial inhomogeneity is more relaxed as the distance from the critical density in the electron heat conduction as shown in FIG. 15. Resultantly, if L_{gap}<<L_{stand}, the spatial inhomogeneity of absorbed laser energy with width L_{gap} due to laser intensity inhomogeneity is relaxed and homogenized within the standoff, so it does not affect the ablation.

In above present techniques, nanosecond pulse laser source is used as the laser source with a pulse width from 1 nanosecond to 40 nanoseconds and the total pulse energy of 1MJ˜10MJ at the center of the cavity of OEC using a number of 10˜10,000 OECs. The wavelength of nanosecond laser sources is from UV (350 nm) to IR (1060 nm).

In present techniques, the word of pulsed laser light source or the laser light source does not include the 2ω or 3ω nonlinear crystals to change the emission wavelength of IR laser light source from IR to green or UV color. After the IR laser pulsed light source, the 2ω or 3ω nonlinear crystals is placed to change wavelength of the laser pulsed laser light source from IR to green or UV, and then the emission wavelength changed laser beams enter into the OEC for amplification. The preference color of laser beams for OEC after the 2ω or 3ω nonlinear crystals is a green color to minimize a damage of the mirrors of the OEC in our present technique. In the claims, the 2ω or 3ω nonlinear crystals is placed between each laser light source and each OEC even if the 2ω or 3ω nonlinear crystals is not mentioned in the claims.

In a preferred example, the present invention provides techniques for combining coherent beam combining (CBC) operably coupled to an optical enhancement cavity for amplifying a seed laser through the CBC, and then through the optical enhancement cavity, as will be further described throughout the present specification and more particularly below.

In an example, the present invention provides a method for coupling an amplified coherent beam combined laser pulse to an optically enhanced cavity. The method includes generating a laser pulse from a source laser device. The method includes generating at least two frequency-shifted reference sidebands in conjunction with the laser pulse in an example. In an example, the two frequency shifted reference sidebands are generated such that each of the two frequency shifted reference side bands is at a lower power than the laser pulse from the source laser device.

In an example, the method includes dividing the pulse laser into a plurality of independent beam paths, e.g., ranging from 2 to 10,000. Each of the independent beam paths has a divided laser pulse. Each of the divided laser pulses has at least two reference side bands, but can be fewer or more. In an example, the method includes increasing an intensity of each of the divided laser pulse using an amplification. The method includes adjusting a phase of each of the divided laser pulses to reduce a destructive interference of one or more of the at least two reference side bands. In an example, the method includes combining, using coherency, each of the divided laser pulses into a single amplified pulse and at least two reference sidebands.

In an example, the method includes propagating the single amplified pulse with the two reference side bands between a pair of mirrors configured to form a cavity region. In an example, the method includes reflecting the at least two reference sidebands from at least one of the mirrors into a photodiode detector device to generate a signal to adjust a frequency of the source laser device using a control method to increase an injection efficiency of the laser pulse from a first efficiency to a second efficiency, where the first efficiency is less than the second efficiency.

In an example, the control method comprises a Pound Drever Hall controls method.

In an alternative example, the present invention provides a source laser system in which the frequency of a pulse generator device is configured to vary a pulse production between 100 kHz to 100 MHz to match a round-trip time of an intracavity laser pulse configured in a cavity region with a cavity length ranging from 1 meter to 1000 meters.

In an alternative example, the present invention provides a method for amplifying a laser pulse from a low power, e.g., on order of 100 Watts, by a factor, e.g., of 1,000,000 times, among others. The method includes performing an active amplification of a laser pulse by pulse division of the laser pulse into a plurality of independent beam paths, e.g., ranging between 8 and 10,000. The method includes coupling each of the beam paths to a rare-earth doped fiber amplifier device followed by coherent combination of each of the independent beam paths to output a single amplified laser pulse, e.g., resulting in at least 1,000 times amplification of an intensity of the laser pulse. The method includes performing a passive amplification of the amplified laser pulse by injection of the amplified laser pulse into an optical cavity comprising a pair of mirror devices configured to form the optical cavity, each of the mirror devices having more than a 99.9% reflectivity of the amplified laser pulse such that a round-trip length of an intracavity laser pulse is matched with a timing of an injection of the amplified laser pulse causing additional amplification of an intensity of the amplified laser pulse to, for example, 1,000 times and greater.

In an example, the present invention provides a method for generating a high intensity pulse laser for a fusion process or other process. In an example, the method includes generation of a continuous wave source laser beam using either an Nd:YAG or rare-earth doped fiber laser medium. In an example, the continuous wave source laser is characterized by a single frequency and having a wavelength, e.g., ranging between 1030-1050 nm. In an example, the method includes shaping the continuous wave laser beam into a gaussian laser pulse using a pulse shaping device capable of generating a laser pulse with a pulse width, e.g., ranging between 200 ps and 20 ns, e.g., at 1 to 100 MHZ pulse frequency. In an example, the pulse shaping device has an acousto-optic modulating device coupled to an arbitrary waveform generator device to interact with the continuous laser outputting the gaussian laser pulse.

In an example, the method includes generating at least two radio frequency sidebands in conjunction with the gaussian laser pulse using an electro-optic modulator device interacting with the gaussian laser pulse. The method includes dividing the gaussian laser pulse into a plurality of laser beam paths using a polarization-based beam splitting device having a half waveplate device coupled to the polarizing beam splitter device configured to divided the gaussian laser pulse into at least two gaussian laser pulses or more of equal power. In an example, the method includes amplifying each of the plurality of laser beam paths using a rare-earth doped fiber amplifier device capable of receiving a divided laser pulse from each of the plurality of laser beam paths from a first intensity level to a second intensity level.

In an example, the method includes combining each of the divided laser pulses using a multi-stage combination device having a polarizing beam splitter device configured to receive at least the two gaussian laser pulses. Each of the two gaussian laser pulses has a polarization orthogonal to another, to coherently combine all the divided laser pulses to form one amplified gaussian laser pulse.

In an example, the method includes detecting a phase of the amplified gaussian laser pulse using a phase measurement system in which a beam sampler device receives a portion of the amplified gaussian laser pulse coupling the sampled laser pulse to a quarter waveplate device coupled to the polarizing beam splitter device to determine a degree of matching the divided laser pulses before the coherent combination of the amplified gaussian laser pulse.

In an example, the method includes modulating a phase of the divided laser pulses using a phase controller system. The two divided laser pulses are operably coupled to photodiode detector device that receives a signal from the divided laser pulses and generates an electronic signal in which the phase is measured by field programmable gate array device that modulates the phase of the divided pulses before the coherent combination to achieve an improved degree of matching between the divided laser pulses. The improved degree of matching is from a first level to a second level.

In an example, the method includes modulating a wavelength of the amplified gaussian laser pulse by using a second harmonic generator device having a half waveplate coupled to a lithium triborate crystal to generates a corrected amplified gaussian laser pulse having doubled frequency as the gaussian laser pulse.

In an example, the method includes injecting the corrected amplified gaussian laser pulse into an optical enhancement cavity. The method includes increasing an amplification of the corrected amplified gaussian laser pulse by using the optical enhancement cavity device having two mirror devices facing each other having a set distance between the two mirror devices.

In an example, the method includes controlling an efficiency factor of injection of the corrected amplified gaussian laser pulse using a Pound Drever Hall system. The Pound Drever Hall system has a quarter waveplate device coupled to a polarizing beam splitter device coupled to a photodiode detector device, which is configured to receives a portion of the corrected amplified laser pulse rejected from the optical enhancement cavity to generates an electronic signal. The electronic signal is received from the field programmable gate array device that modulates the frequency of the continuous wave source laser to increase an injection efficiency from a first factor to a second factor.

Further details of the present method can be found throughout the present specification and more particularly below.

In an alternative example, the present invention provides a laser system. The system has a single frequency continuous wave fiber laser source device (“laser device”) with a center wavelength, e.g., ranging between 1030 and 1050 nm with at least 0.1 nm resolution, to achieve an amplification gain and a stable frequency. In an example, the system has an arbitrary waveform generator device coupled to a RF driver device coupled to an acousto-optic modulator device coupled to the laser device capable of generating one or more laser pulses with either gaussian or flat-top shape, e.g., ranging between 100 ps and 20 ns. In an example, the system has an electro-optic modulator device coupled to the laser device capable of generating one or more reference sidebands. In an example, the system has a beam splitter device coupled to the laser device. The beam splitter device is configured to receive laser beam from the laser device and divide the laser beam into N paths, where N is an integer, e.g., from 2 to 10,000, each laser beam in each path is amplified from a first energy level to a second energy level. In an example, the system has an auxiliary phase modulation device coupled to each N divided laser beam. The auxiliary phase modulation device is capable of shifting a phase of each laser pulse, e.g., at a MHz frequency. In an example, the system has a combiner device configured to receive the N laser beams and configured to spatially combine the N laser beams into an amplified pulse. In an example, the system has a second harmonic generation crystal device configured to receive the amplified pulse generating a frequency doubled laser pulse. In an example, the system has a third harmonic generation crystal device configured to receive the amplified pulse and the frequency doubled laser pulse generating a frequency tripled laser pulse.

In an example, the system has a Fabry Perot optically enhanced cavity (OEC) configured to receive the frequency tripled laser pulse. In an example, the Fabry Perot optical cavity comprising a first mirror device and a second mirror device, and a free space defined between the first mirror device and the second mirror device to form the Fabry Perot optical cavity. The frequency tripled amplified pulse propagates in the Fabray Perot optical cavity increases in energy intensity from a first intensity to a second intensity to an Mth intensity for M cycles between the first mirror device and the second mirror device, e.g., where M is greater than 10,000 cycles.

In an example, the system also has a polarization controlled beam dividing system having a half wave plate device coupled to a polarizing beam splitter device coupled to the laser device such that the half wave plate device is adjusted so that upon exiting the polarizing beam splitter device a laser pulse is divided into two laser pulses with a high efficiency each having equal power, which is then repeated between 2 and 1,000 times.

In an example, the system has a rare-earth doped fiber amplifier device operably coupled to each divided laser pulse that upon entering the rare earth doped fiber amplified device amplifies the divided laser pulse from a first power to a a second power, where the second power is higher than the first power.

In an example, the system has an alignment system. In an example, the alignment system has a charged-coupled camera device coupled to a piezo-mounted mirror device placed before the rare-earth doped fiber amplifier device capable of receiving a portion of the amplified divided laser pulse measuring its position on the detector device and producing an electronic signal. The alignment system has a feedback module that accepts the electronic signal from the charged coupled camera device and configured to adjusts the piezo mounted mirror device to increase amplification from a first level to a second level through the rare-earth doped fiber amplifier device.

In an example, the system has a polarization-based beam combiner device coupled to at least two of the divide laser pulse paths. The polarization beam combiner device is capable of injecting each of the two divided laser pulses and coherently combining two pulses into one amplified pulse, and then other pairs of divided laser pulses are coherently combined into a single amplified pulse.

In an example, the system has a controller system having a field programmable gate array device coupled to the laser device and a detection device such that a feedback signal from the frequency tripled laser pulse is detected from the detection device and transferred to the controller system to adjust a frequency and a phase of the laser beam from the laser device to adjust to achieve an injection of the laser beam into the OEC utilizing a Pound Drever Hall method.

In an example, the system has a phase controller system to phase-match at least two divided laser pulses. In an example, the phase controller system has a beam sampling device coupled to the laser beam pathway of the combined pulses capable of measuring a sample of the pulse at MHz frequencies to increase combination efficiency and beam uniformity of the combined pulse. In an example, the system has a quarter waveplate device converting the polarization of the sampled pulse into equal amounts vertical and horizontal light. In an example, the system has a polarizing beam splitting device capable of splitting the beam into separate horizontal and vertical polarization components. In an example, the system has one or more photodiode conversion devices capable converting the laser pulse to an electronic signal. In an example, the system has a field programmable gate array device capable of measuring the electronic signal generated from the conversion device and producing and delivering a radio frequency signal to the phase controlling device.

In an example, the system has a Pound Drever Hall measurement system. In an example, the measurement system has a quarter waveplate device capable of shifting the phase of the amplified laser pulse by 90 degrees producing circularly polarized light on the first pass and horizontally polarized light after two passes. In an example, the measurement system has a planar concave cavity mirror mounted to a 6-axis mirror mount device capable of injecting the laser pulse into the cavity and reflecting and rejecting frequencies not resonant with the cavity. In an example, the measurement system has a polarizing beam splitter device that reflects the rejected frequencies along a new path. In an example, the measurement system has an optoelectronic detector device that can measure the frequency of the rejected light and convert the electromagnetic pulse into an electronic signal. In an example, the measurement system has a field programmable gate array device capable of measuring the electronic signal and creating a feedback loop to adjust the frequency of the source laser to optimize injection into the laser cavity device.

Further details of the present system can be found throughout the present specification and more particularly below.

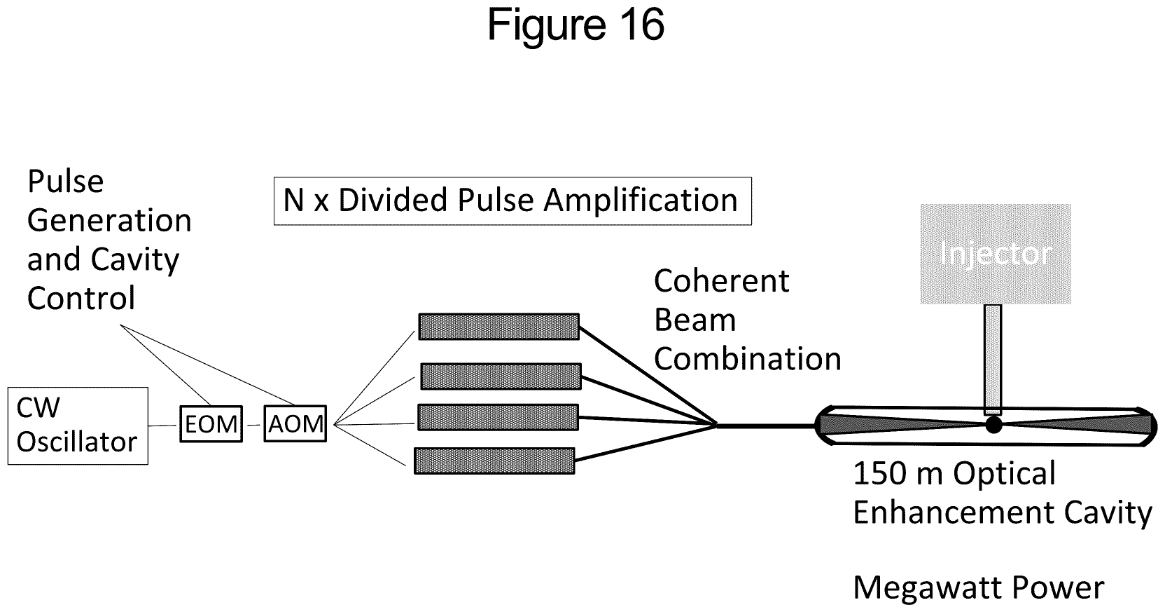

FIG. 16 is a simplified overall diagram of a coherent beam combining laser system coupled to an optical enhancement cavity according to an example of the present invention. In an example, a CW laser with a center wavelength, e.g., between 1030 nm and 1050 nm, is generated with a CW oscillator device. The CW laser is coupled to the EOM (electro optical modulator) device, which upon receiving the CW laser, adds two frequency reference bands one lower and the other higher in frequency to the CW laser center frequency, and the bands equidistant to the CW laser center frequency. The CW laser with two reference sidebands is then coupled to an AOM device, which upon receiving the CW laser and references, generates a gaussian laser pulse with pulse widths, e.g., ranging from 1 picosecond- 50 nanosecond, but can be others.

In an example, the gaussian laser pulse is then actively amplified using the coherent beam combination laser system. In an example, the gaussian laser pulse is divided into N laser paths, where N is any number greater than 1 and as high as 10,000. Upon division into N laser paths, the divided gaussian laser pulses are coupled to a fiber amplifier device, which receives a laser pulse with O energy level and amplifies the laser pulse to energy P, where each of O and P is a value. The amplified laser pulses are then recombined from N laser paths with energy P into a single amplified laser with energy N×P.

In an example, the amplified laser pulse is then coupled to the Optical Enhancement Cavity (OEC) laser system. The OEC laser system receives an amplified laser pulse with energy level N×P and further amplifies the laser pulse to an energy level T, which is a value. Upon amplification to energy level T, the fusion target is injected into the center of the cavity with the target injector device and timed to interact with the intracavity laser pulse.

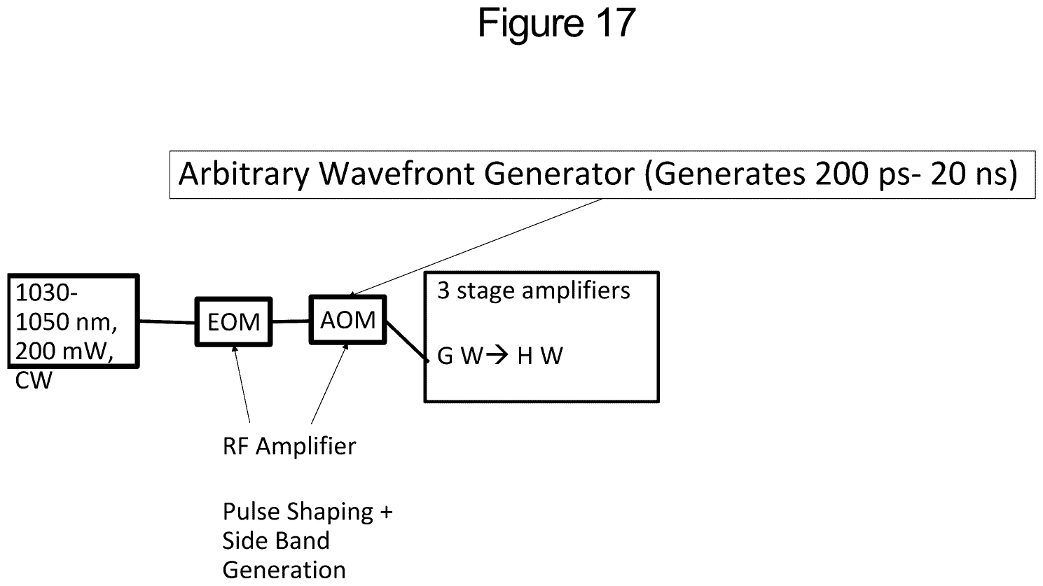

FIG. 17 is a. simplified diagram of a source laser system according to an example of the present invention. In an example, a source laser oscillator generates a CW laser with center wavelengths, e.g., within the range of 1030 and 1050 nm, but can be others. The CW laser is coupled to an EOM device, which upon receiving the CW laser, adds two reference sidebands to the CW laser. An arbitrary waveform generator device is coupled to an AOM (acousto optical modulator) device that is coupled to the CW laser with reference sidebands, which upon receiving the laser, generates a laser pulse with gaussian shape and a pulse width, e.g., between 1 ps and 50 ns. The gaussian laser pulse with reference side bands is then amplified in a 3-stage preamplifier device from energy level G to energy level H, where each of G and H is a value. In an example, the output of the amplified laser pulse is then coupled to the CBC laser system.

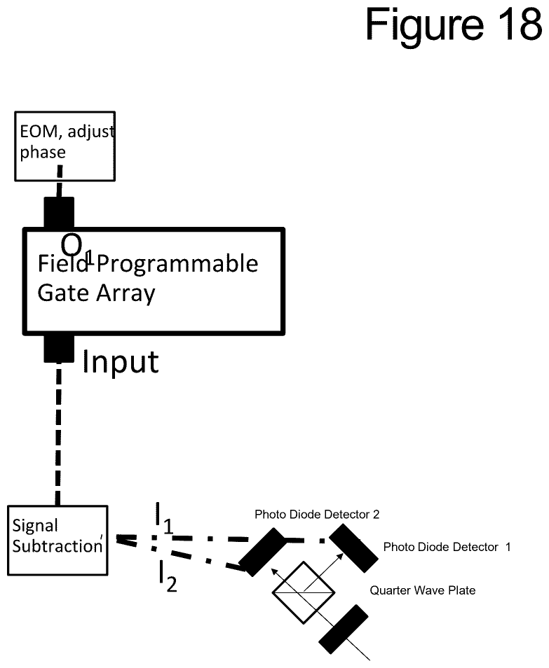

FIG. 18 is a simplified diagram of a field programmable gate array system according to an example of the present invention. In an example, a sample of the combined gaussian laser pulse is coupled to a quarter wave plate which receives a laser pulse with linear polarization R and outputs a laser pulse with circular polarization S. The laser pulse with circular polarization is coupled to a polarizing beam splitter device, which divides the beam into two paths, one of which is transmitted through the polarizing beam splitter device and the other is reflected orthogonal to the transmitted laser pulse. The two laser pulses are coupled to two photodiode detector devices, which receive the laser pulses and outputs an electronic signal. The two electronic signals are coupled to the field programmable gate array device, which receives the electronic signals and outputs a radio frequency signal. This radio frequency signal is then received by an EOM device, modulating the phase of the pre-combined laser pulses to increase combination efficiency.

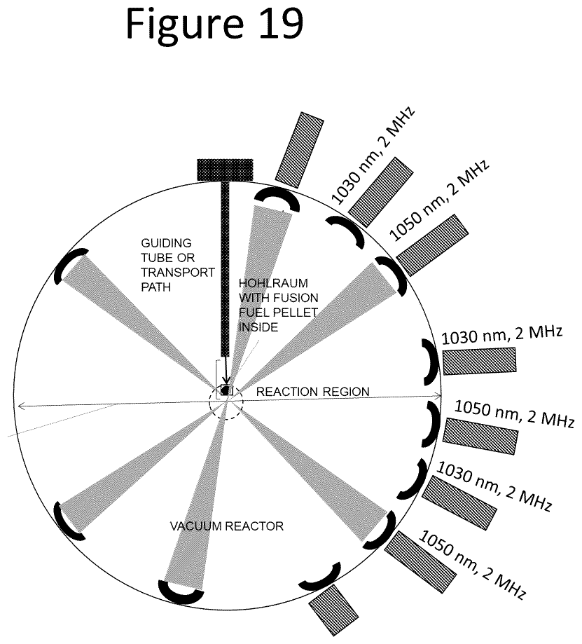

FIG. 19 is a simplified diagram of a laser fusion reactor configured with a plurality of optical enhancement cavities according to an example of the present invention. In an example, each cavity is coupled to a CBC laser system firing at 2 MHz, generating two counter propagating laser pulses in each cavity. The wavelength of each cavity alternates between 1030 nm and 1050 nm, but can be others to decrease scattering of the laser pulses at the center of the fusion reactor upon interaction with the fusion target fuel.

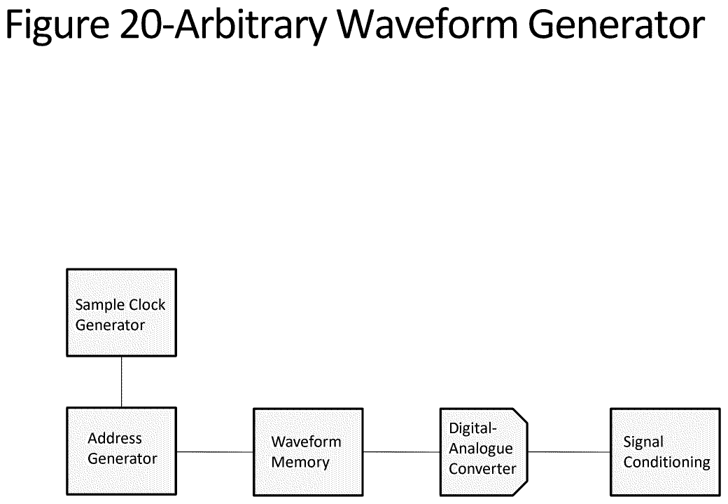

FIG. 20 is a simplified diagram of a waveform generator according to an example of the present invention. A sample clock generator coupled to an address generator produces an electronic signal that is received by the waveform memory to generate a temporal pulse shape signal. In an example, the temporal pulse shape is then coupled to the digital-analogue converter receiving the digital temporal pulse shape signal and outputting an analogue pulse shape signal. The output analogue pulse shape signal is then used for signal conditioning, shaping the CW laser into a gaussian laser pulse.

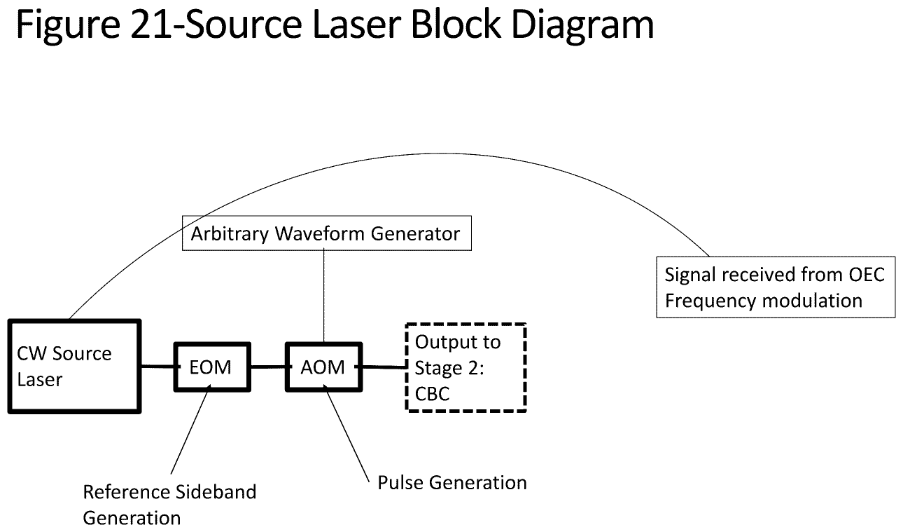

FIG. 21 is a simplified diagram of a source laser according to an example of the present invention. In an example, a signal generated from the laser pulse rejected from the OEC is coupled to the CW source laser, adjusting the center frequency of the source laser from frequency E to frequency F, each of which is a value. The CW laser with frequency F is then circulated through the source laser system and injected into the OEC with less of the laser pulse rejected.

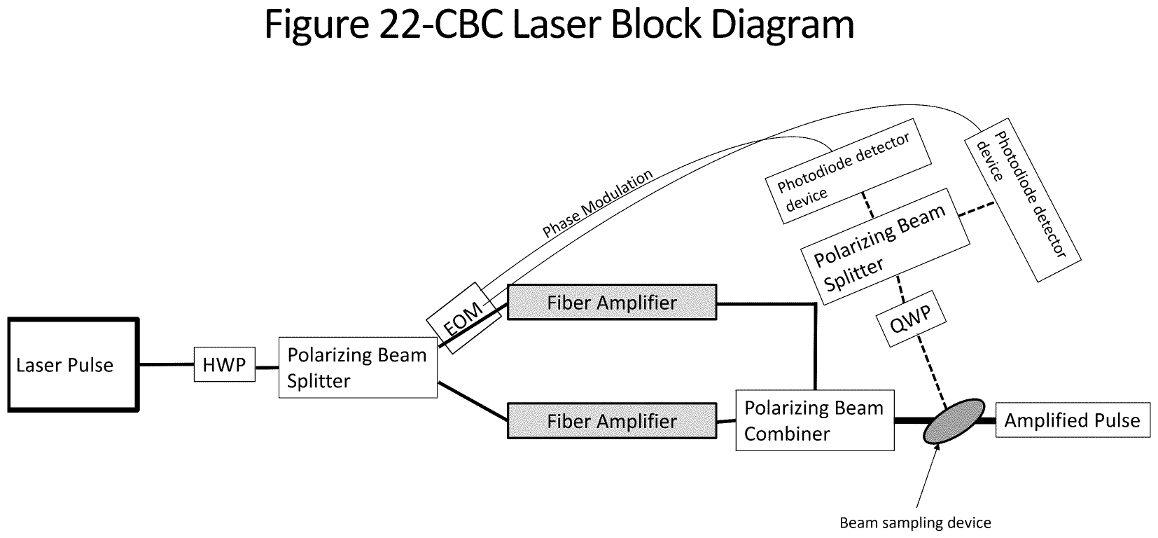

FIG. 22 is a more detailed diagram of a coherent beam combining (CBC) laser system according to an example of the present invention. In an example, the gaussian laser is coupled to a half wave plate device coupled to a polarizing beam splitter, producing two gaussian laser pulses. The two gaussian laser pulses are each coupled to a fiber amplifier device, amplifying the laser from a lower energy level N to a higher energy level M. The two amplified laser pulses are then coupled into a polarizing beam splitter device, combining the two laser pulses with energy level M (where O and M are each a value) into a combined laser pulse with higher energy level O. The combined laser pulse is coupled to a beam sampling device which receives the laser pulse and reflects a small sampled laser pulse. The sampled laser pulse is coupled to a quarter waveplate device coupled to a polarizing beam splitter device, splitting the sampled laser pulse into two laser pulses propagating orthogonal to each other. The two laser pulses are then coupled to two photodiode detector devices which receive the laser pulse and output two electronic signals. The two electronic signals are subtracted from each other, the output of which is coupled to a EOM device. The EOM device, upon receiving the subtracted electronic signal modulates the phase of the two pre-amplified gaussian laser pulses to increase combination of the two amplified laser pulses.

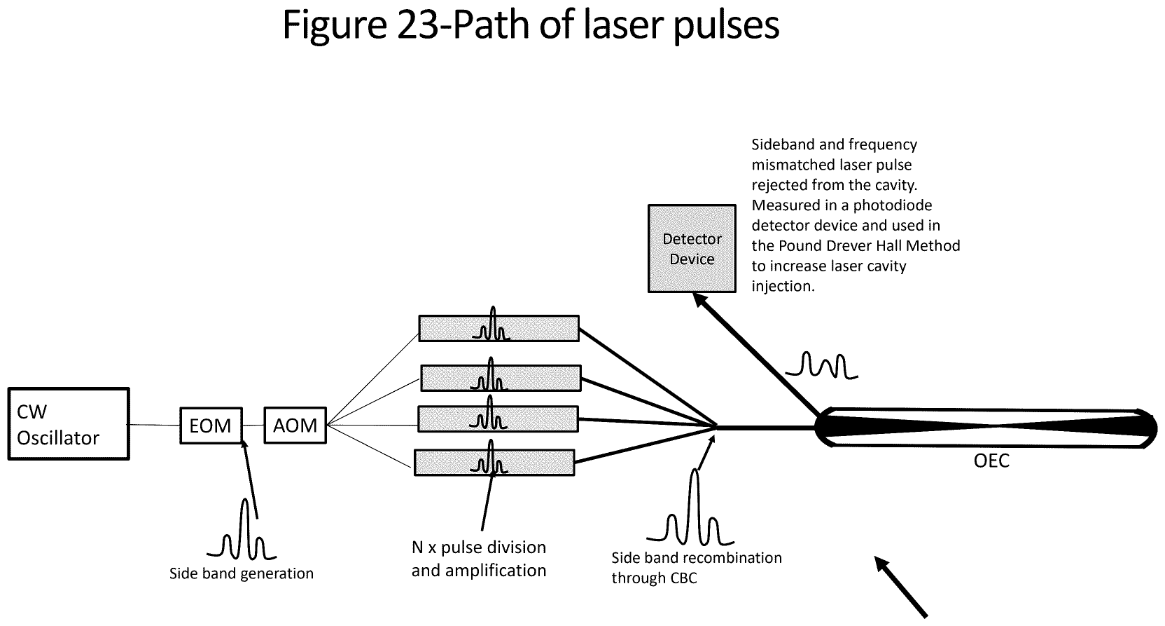

FIG. 23 is a more detailed diagram of a CBC laser system with sidebands coupled to an optical enhancement cavity according to an example of the present invention. In an example, a singular laser pulse with center band and sidebands is generated from the source laser system. In the coherent beam combination laser system the laser pulse with sidebands is divided into N (which is an integer greater than two) laser pulses, each with their own center band and sidebands. Upon combination into a single amplified laser pulse, the center band and sidebands combine into a single amplified set of center band and side bands. Upon coupling to the OEC, the center band is injected through the injection cavity mirror with efficiency L, which is a value. The center side band that is not injected into the cavity mirror and sidebands are redirected towards a detector device that modulates the frequency and phase of the source laser system to increase the injection efficiency of the following laser pulses.

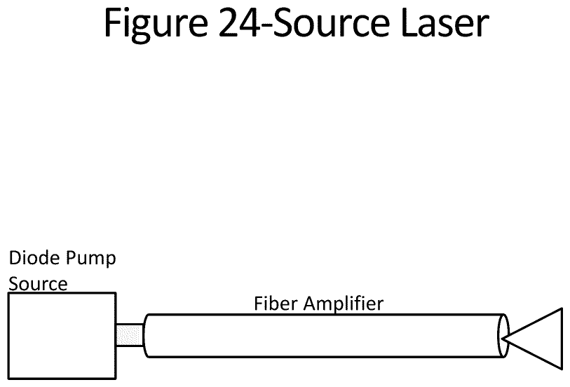

FIG. 24 is a simplified diagram of a source laser according to an example of the present invention. As shown, the source laser has a diode pump source and a fiber amplifier. The diode pump laser generates a CW laser that is coupled into the fiber amplifier. The fiber amplifier comprises of rare-earth doped fiber, that upon receiving the CW laser from the diode pump source, amplifies the energy of the CW laser from a lower energy level N to a higher energy level M, where each of N and M is a value.

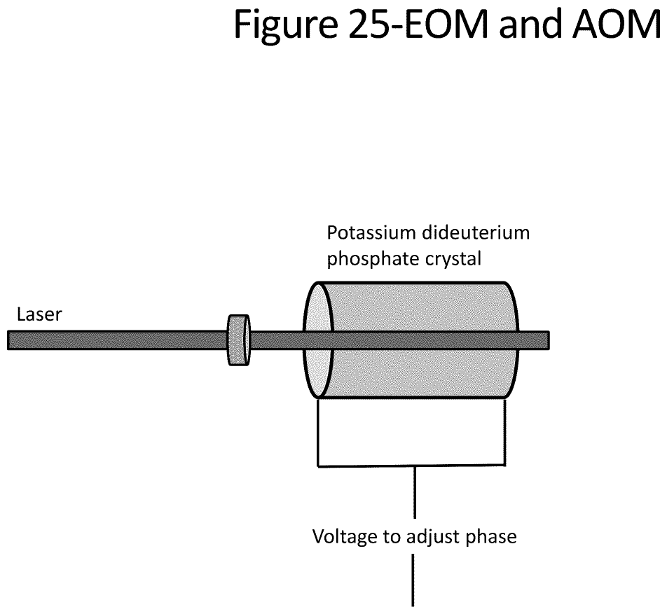

FIG. 25 is a simplified diagram of a laser configured for frequency multiplication according to an example of the present invention. As shown is a simplified diagram for an electro-optic modulator and acousto-optic modulator device. The electro-optic modulator device receives a gaussian laser pulse with phase N and modulates the phase of the laser pulse outputting a gaussian laser pulse with phase M, where each of N and M is a value. The acousto-optic modulator device receives a gaussian laser pulse with amplitude O and modulates the amplitude of the laser pulse outputting a gaussian laser pulse with amplitude P, where each of O and P is a value.

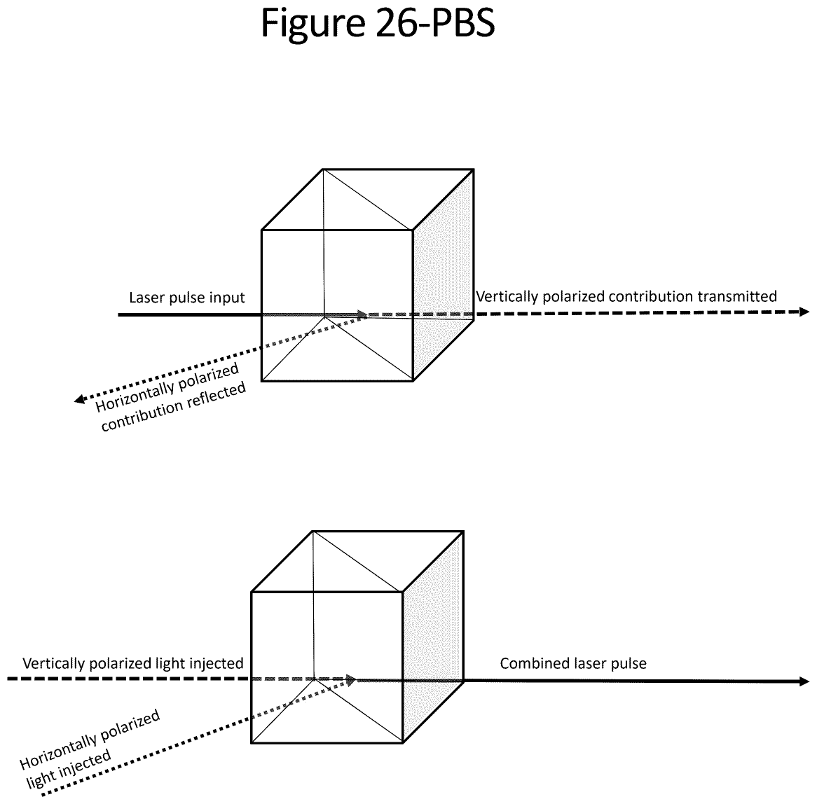

FIG. 26 are simplified illustrations of laser splitting and combinations according to an example of the present invention. As shown is a polarizing splitter device used in two different applications. Upon the polarizing beam splitter device receiving a 45^{O} linearly polarized gaussian laser pulse, the laser pulse will separate into two gaussian laser pulses of equal energy. Each laser pulse will be comprised of either completely horizontally or vertically polarized light. In a second example, upon the polarizing beam splitter receiving two linearly polarized gaussian laser pulses comprising of vertically and horizontally polarized light, the polarizing beam splitter device will combine the two gaussian laser pulses into a single amplified gaussian laser pulse with 45^{O} linear polarization.

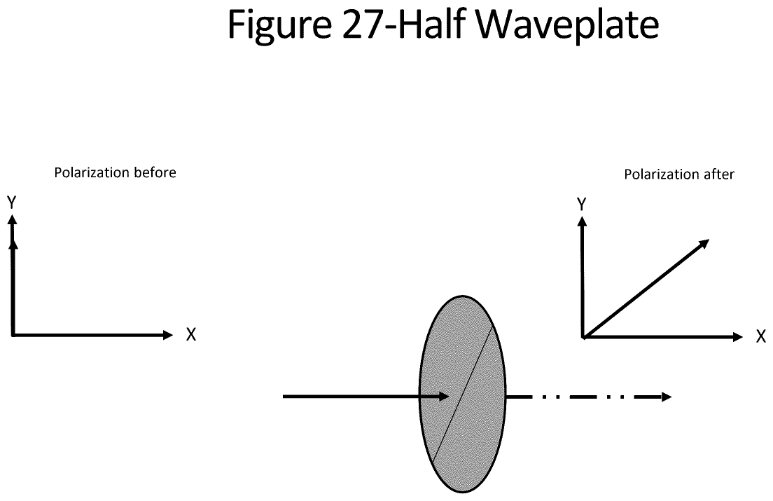

FIG. 27 is a simplified diagram of a half wave plate device according to an example of the present invention. As shown is a gaussian laser pulse with a predetermined linear, vertical polarization propagating towards the half wave plate device. Upon the half wave plate device receiving the gaussian laser pulse, the polarization of the gaussian laser pulse is converted from linear, vertical polarization to a polarization comprising of equal amounts vertical and horizontal linearly polarized light. The gaussian laser pulse with equal amounts vertical and horizontal linearly polarized light is then ejected from the half wave plate device and propagates throughout the rest of the laser system.

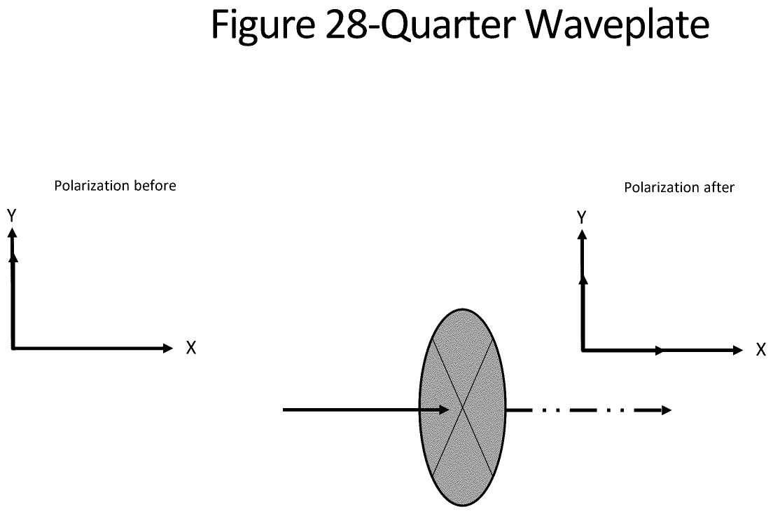

FIG. 28 is a simplified diagram of a quarter wave plate device according to an example of the present invention. As shown is a gaussian laser pulse with a predetermined vertical linear polarization propagating towards the quarter wave plate device. Upon the quarter wave plate device receiving the gaussian laser pulse, the polarization of the gaussian laser pulse is converted from vertical linear polarization to a polarization comprising of equal amounts vertical and horizontal circularly polarized light. The gaussian laser pulse with equal amounts vertical and horizontal circularly polarized light is then ejected from the quarter wave plate device and propagates throughout the rest of the laser system.

In an example, the present invention provides a fusion reactor system. The system has a plurality of optical enhancement cavities. Each optical enhancement cavity is configured with a pulsed laser beam amplified by the optical enhancement cavity (OEC) using a laser light source coupled to a pair of mirrors configured to irradiate a target or a capsule which contains a target inside. The system has a number of the pulsed laser beams amplified by the plurality of OECs is characterized by a number ranging from 10-10,000 and a peak wavelength of the laser light source ranging from 1030 nm to 1050 nm characterizing each of the pulsed laser beams. In an example, the system has a first group of pulsed laser beams having a first wavelength range and a second group of pulsed laser beams having a second wavelength range. The first wavelength range is different from the second wavelength range and configured to suppress one or more parametric instabilities.

In an example, each pulsed laser beam amplified by the OEC is focused into a size less than 500 microns at a center region of the OEC or each pulsed laser beam amplified by the OEC is focused into a size less than 200 microns at a center region of the OEC or each pulsed laser beam amplified by the OEC is focused into a size less than 100 microns at a center region of the OEC.

In an example, the present invention provides a method of operating a fusion reactor system. The method includes providing a plurality of optical enhancement cavities. Each optical enhancement cavity is configured with a pulsed laser beam amplified by the optical enhancement cavity (OEC) using a laser light source coupled to a pair of mirrors configured to irradiate a target or a capsule which contains a target inside. The method includes irradiating a number of the pulsed laser beams amplified by the plurality of OECs characterized by a number ranging from 10-10,000 and having a peak wavelength of the laser light source ranging from 1030 nm to 1050 nm characterizing each of the pulsed laser beams such that a first group of pulsed laser beams having a first wavelength range and a second group of pulsed laser beams having a second wavelength range. In an example, the first wavelength range is different from the second wavelength range. The method includes causing suppression of one or more parametric instabilities by use of at least the different first wavelength range and the second wavelength range such that the first wavelength range and the second wavelength range interact in a predetermined range.

In an example, each OEC is configured with a different peak wavelength by surrounding a reactor housing configured with the plurality of OECs to suppress the parametric instabilities in a laser fusion reaction. In an example, the plurality of OECs is configured in adjacent pairs of OECs, each adjacent pair of OECs has a first OEC in the first wavelength range and a second OEC in the second wavelength range. In an example, each OEC has the laser light source configured with one or more Nd: YAG or rare-earth doped fiber lasers or others.

In an example, the method includes focusing each pulsed laser beam amplified by the OEC into a size less than 500 microns at a center region of the OEC or focusing each pulsed laser beam amplified by the OEC into a size less than 200 microns at a center region of the OEC or focusing each pulsed laser beam amplified by the OEC into a size less than 100 microns at a center region of the OEC.

In an example, the first group and the second group are configured such that a distinct wavelength within each OEC increases an effective bandwidth at an interface region between the pulsed laser beam and the target, thereby reducing an amount of light scattered. In an example, each pulsed laser beam amplified by the OEC irradiates a target surface or critical density surface with reducing overlapping from a first level to a second level ensuring that an incident light reaches a critical density and achieves absorption through an inverse Bremsstrahlung process. In an example, the first group and the second group are arranged such that a reflected or scattered light from the target is reduced to a desired value, thereby, preventing an interference between a pair of neighboring laser beams and thereby suppressing one or more parametric instabilities. In an example, the plurality of OECs is characterized by a uniform irradiation intensity distribution of each pulsed laser beam amplified by the OEC irradiated into the target using the plurality of laser beams with a total pulse energy from 1MJ to 10MJ and a pulse width of 1 ns˜40 ns, among others. In an example, the one or more parametric instabilities includes at least one of a TBD, SRS, or SBS.

In an example, the present invention provides a fusion reactor system. The system has a plurality of optical enhancement cavities, each optical enhancement cavity is configured with a pulsed laser beam amplified by the optical enhancement cavity (OEC) using a laser light source coupled to a pair of mirrors configured to irradiate a target or a capsule which contains a target inside. The system has a number of the pulsed laser beams amplified by the plurality of OECs is characterized by a number ranging from 10-10,000, among others. The system has a first group of pulsed laser beams having a first wavelength range comprising (or consists of) 1030 to 1040 nm from a first laser light source amplified from a first coherent beam combining system and a second group of pulsed laser beams having a second wavelength range comprising (or consists of) 1040 to 1050 from a second laser light source amplified from a second coherent beam combining system. In an example, the first wavelength range is different from the second wavelength range and configured to suppress one or more parametric instabilities.

In an example, the present invention provides a system for amplifying a seed laser. The system has a seed laser device generating a laser beam. The system has a splitter device coupled to the seed laser device to generate a plurality of divided laser beams from the laser beam. The system has an amplifier device coupled to each of the plurality of divided laser beams to amplify each of the plurality of laser beams to generate a plurality of amplified laser beams. In an example, the system has a coherent beam combining system coupled to the plurality of amplified laser beams and configured to generate a single amplified laser beam. The system has an optical enhancement cavity comprising a pair of mirrors configured to propagate and increase an intensity of the single amplified laser beam in a free space between the pair of mirrors.

Further details of an optical enhancement cavity using the Fabry Perot cavity is found in a patent application titled “A FAST IGNITION FUSION SYSTEM AND METHOD,” in the names of Shuji Nakamura and Hiroaki Ohta listed under U.S. Ser. No. 18/319,368 filed May 17, 1923, commonly assigned, and hereby incorporated by reference in their entirety.

While the above is a full description of the specific examples, various modifications, alternative constructions and equivalents may be used. As an example, the packaged device can include any combination of elements described above, as well as outside of the present specification. In an example, the high intensity laser forms a resonator between the pair of mirror devices using constructive interference of each of the laser beams. In an example, the first path with the high intensity pulse laser is provided in a resonator device. In an example, the present invention provides a system and method to generate aa concentric or spherical resonator within a reaction region to focus laser light at a center of the reactor. Additionally, the terms first, second, third. and final do not imply order in one or more of the present examples. Moreover, capital letters A, B, C, D, E, F, G, H, I, J, K, L, M, N, O, P, Q, R, S, T, U, V, and others represent a value, and do not imply order. Therefore, the above description and illustrations should not be taken as limiting the scope of the present invention which is defined by the appended claims.

1. A method for coupling an amplified coherent beam combined laser pulse to an optically enhanced cavity comprising:
generating a laser pulse from a source laser device;
generating at least two frequency-shifted reference sidebands in conjunction with the laser pulse, each of the two frequency shifted reference side bands being at a lower power than the laser pulse from the source laser device;
dividing the pulse laser into a plurality of independent beam paths ranging from 2 to 10,000, each of the independent beam paths having a divided laser pulse, each of the divided laser pulses having at least two reference side bands;
increasing an intensity of each of the divided laser pulse using an amplification;
adjusting a phase of each of the divided laser pulses to reduce a destructive interference of one or more of the at least two reference side bands;
combining, using coherency, each of the divided laser pulses into a single amplified pulse and at least two reference sidebands;
propagating the single amplified pulse with the two reference side bands between a pair of mirrors configured to form a cavity region;
reflecting the at least two reference sidebands from at least one of the mirrors into a photodiode detector device to generate a signal to adjust a frequency of the source laser device using a control method to increase an injection efficiency of the laser pulse from a first efficiency to a second efficiency, where the first efficiency is less than the second efficiency.

2. The method of claim 1 wherein the control method comprises a Pound Drever Hall controls method.

3. A method for amplifying a laser pulse from a low power on order of 100 Watts by a factor of 1,000,000 times, the method comprising:
performing an active amplification of a laser pulse by pulse division of the laser pulse into a plurality of independent beam paths ranging between 8 and 10,000, and coupling each of the beam paths to a rare-earth doped fiber amplifier device followed by coherent combination of each of the independent beam paths to output a single amplified laser pulse resulting in at least 1,000 times amplification of an intensity of the laser pulse; and
performing a passive amplification of the amplified laser pulse by injection of the amplified laser pulse into an optical cavity comprising a pair of mirror devices configured to form the optical cavity, each of the mirror devices having more than a 99.9% reflectivity of the amplified laser pulse such that a round-trip length of an intracavity laser pulse is matched with a timing of an injection of the amplified laser pulse causing additional amplification of an intensity of the amplified laser pulse to 1,000 times and greater.

4. A source laser system in which the frequency of a pulse generator device is configured to vary a pulse production between 100 kHz to 100 MHz to match a round-trip time of an intracavity laser pulse configured in a cavity region with a cavity length ranging from 1 meter to 1000 meters.

5. A method for generating a high intensity pulse laser for a fusion process, the method comprising:
generation of a continuous wave source laser beam using either an Nd:YAG or rare-earth doped fiber laser medium, the continuous wave source laser being characterized by a single frequency and having a wavelength ranging between 1030-1050 nm;
shaping the continuous wave laser beam into a gaussian laser pulse using a pulse shaping device capable of generating a laser pulse with a pulse width ranging between 200 ps and 20 ns at 1 to 100 MHZ pulse frequency, the pulse shaping device having an acousto-optic modulating device coupled to an arbitrary waveform generator device to interact with the continuous laser outputting the gaussian laser pulse;
generating at least two radio frequency sidebands in conjunction with the gaussian laser pulse using an electro-optic modulator device interacting with the gaussian laser pulse;
dividing the gaussian laser pulse into a plurality of laser beam paths using a polarization-based beam splitting device having a half waveplate device coupled to the polarizing beam splitter device configured to divided the gaussian laser pulse into at least two gaussian laser pulses or more of equal power;
amplifying each of the plurality of laser beam paths using a rare-earth doped fiber amplifier device capable of receiving a divided laser pulse from each of the plurality of laser beam paths from a first intensity level to a second intensity level;
combining each of the divided laser pulses using a multi-stage combination device having a polarizing beam splitter device configured to receive at least the two gaussian laser pulses, each of the two gaussian laser pulses having a polarization orthogonal to another, to coherently combine all the divided laser pulses to form one amplified gaussian laser pulse;
detecting a phase of the amplified gaussian laser pulse using a phase measurement system in which a beam sampler device receives a portion of the amplified gaussian laser pulse coupling the sampled laser pulse to a quarter waveplate device coupled to the polarizing beam splitter device to determine a degree of matching the divided laser pulses before the coherent combination of the amplified gaussian laser pulse;
modulating a phase of the divided laser pulses using a phase controller system, the two divided laser pulses being operably coupled to photodiode detector device that receives a signal from the divided laser pulses and generates an electronic signal in which the phase is measured by field programmable gate array device that modulates the phase of the divided pulses before the coherent combination to achieve an improved degree of matching between the divided laser pulses;
modulating a wavelength of the amplified gaussian laser pulse by using a second harmonic generator device having a half waveplate coupled to a lithium triborate crystal to generates a corrected amplified gaussian laser pulse having doubled frequency as the gaussian laser pulse;
injecting the corrected amplified gaussian laser pulse into an optical enhancement cavity;
increasing an amplification of the corrected amplified gaussian laser pulse by using the optical enhancement cavity device having two mirror devices facing each other having a set distance between the two mirror devices;
controlling an efficiency factor of injection of the corrected amplified gaussian laser pulse using a Pound Drever Hall system, the Pound Drever Hall system having a quarter waveplate device coupled to a polarizing beam splitter device coupled to a photodiode detector device, the photodiode detector device being configured to receives a portion of the corrected amplified laser pulse rejected from the optical enhancement cavity to generates an electronic signal which is received from the field programmable gate array device that modulates the frequency of the continuous wave source laser to increase an injection efficiency from a first factor to a second factor.

6. A laser system comprising:
a single frequency continuous wave fiber laser source device (“laser device”) with a center wavelength ranging between 1030 and 1050 nm with at least 0.1 nm resolution to achieve an amplification gain and a stable frequency;
an arbitrary waveform generator device coupled to a RF driver device coupled to an acousto-optic modulator device coupled to the laser device capable of generating one or more laser pulses with either gaussian or flat-top shape and ranging between 100 ps and 20 ns;
an electro-optic modulator device coupled to the laser device capable of generating one or more reference sidebands;
a beam splitter device coupled to the laser device, and configured to receive laser beam from the laser device and divide the laser beam into N paths, where N is an integer from 2 to 10,000, each laser beam in each path is amplified from a first energy level to a second energy level;
an auxiliary phase modulation device coupled to each N divided laser beam, capable of shifting a phase of each laser pulse at a MHz frequency;
a combiner device configured to receive the N laser beams and configured to spatially combine the N laser beams into an amplified pulse;
a second harmonic generation crystal device configured to receive the amplified pulse generating a frequency doubled laser pulse;
a third harmonic generation crystal device configured to receive the amplified pulse and the frequency doubled laser pulse generating a frequency tripled laser pulse;
a Fabry Perot optically enhanced cavity (OEC) configured to receive the frequency tripled laser pulse, and the Fabry Perot optical cavity comprising a first mirror device and a second mirror device, and a free space defined between the first mirror device and the second mirror device to form the Fabry Perot optical cavity such that the frequency tripled amplified pulse propagating in the Fabray Perot optical cavity increases in energy intensity from a first intensity to a second intensity to an Mth intensity for M cycles between the first mirror device and the second mirror device, where M is greater than 10,000 cycles.

7. The system of claim 6 further comprising a polarization controlled beam dividing system having a half wave plate device coupled to a polarizing beam splitter device coupled to the laser device such that the half wave plate device is adjusted so that upon exiting the polarizing beam splitter device a laser pulse is divided into two laser pulses with a high efficiency each having equal power, which is then repeated between 2 and 1,000 times.

8. The system of claim 6 further comprising a rare-earth doped fiber amplifier device operably coupled to each divided laser pulse that upon entering the rare earth doped fiber amplified device amplifies the divided laser pulse from a first power to a second power, where the second power is higher than the first power.

9. The system of claim 8 further comprising an alignment system.

10. The system of claim 9 wherein the alignment system comprising:
a charged-coupled camera device coupled to a piezo-mounted mirror device placed before the rare-earth doped fiber amplifier device capable of receiving a portion of the amplified divided laser pulse measuring its position on the detector device and producing an electronic signal.

11. The system of claim 10 wherein the alignment system comprising:
a feedback module that accepts the electronic signal from the charged coupled camera device and configured to adjusts the piezo mounted mirror device to increase amplification from a first level to a second level through the rare-earth doped fiber amplifier device.

12. The system of claim 6 further comprising a polarization-based beam combiner device coupled to at least two of the divide laser pulse paths, the polarization beam combiner device capable of injecting each of the two divided laser pulses and coherently combining two pulses into one amplified pulse, and then other pairs of divided laser pulses are coherently combined into a single amplified pulse.

13. The system of claim 6 further comprising a controller system having a field programmable gate array device coupled to the laser device and a detection device such that a feedback signal from the frequency tripled laser pulse is detected from the detection device and transferred to the controller system to adjust a frequency and a phase of the laser beam from the laser device to adjust to achieve an injection of the laser beam into the OEC utilizing a Pound Drever Hall method.

14. The system of claim 6 further comprising a phase controller system to phase-match at least two divided laser pulses, the phase controller system comprising:
a beam sampling device coupled to the laser beam pathway of the combined pulses capable of measuring a sample of the pulse at MHz frequencies to increase combination efficiency and beam uniformity of the combined pulse;
a quarter waveplate device converting the polarization of the sampled pulse into equal amounts vertical and horizontal light;
a polarizing beam splitting device capable of splitting the beam into separate horizontal and vertical polarization components;
one or more photodiode conversion devices capable converting the laser pulse to an electronic signal; and
a field programmable gate array device capable of measuring the electronic signal generated from the conversion device and producing and delivering a radio frequency signal to the phase controlling device.

15. The system of claim 6 further comprising a Pound Drever Hall measurement system comprising:
a quarter waveplate device capable of shifting the phase of the amplified laser pulse by 90 degrees producing circularly polarized light on the first pass and horizontally polarized light after two passes.

16. The system of claim 15 wherein the Pound Drever Hall measurement system further comprising:
a planar concave cavity mirror mounted to a 6-axis mirror mount device capable of injecting the laser pulse into the cavity and reflecting and rejecting frequencies not resonant with the cavity.

17. The system of claim 16 wherein the Pound Drever Hall measurement system further comprising:
a polarizing beam splitter device that reflects the rejected frequencies along a new path.

18. The system of claim 17 wherein the Pound Drever Hall measurement system further comprising:
an optoelectronic detector device that can measure the frequency of the rejected light and convert the electromagnetic pulse into an electronic signal.

19. The system of claim 18 wherein the Pound Drever Hall measurement system further comprising:
a field programmable gate array device capable of measuring the electronic signal and creating a feedback loop to adjust the frequency of the source laser to optimize injection into the laser cavity device.

20. A system for amplifying a seed laser, the system comprising:
a seed laser device generating a laser beam;
a splitter device coupled to the seed laser device to generate a plurality of divided laser beams from the laser beam;
an amplifier device coupled to each of the plurality of divided laser beams to amplify each of the plurality of laser beams to generate a plurality of amplified laser beams;
a coherent beam combining system coupled to the plurality of amplified laser beams and configured to generate a single amplified laser beam; and
an optical enhancement cavity comprising a pair of mirrors configured to propagate and increase an intensity of the single amplified laser beam in a free space between the pair of mirrors.
